(19) United States
(12) Patent Application Publication
(10) Pub. No.: US 2025/0191334 A1
(43) Pub. Date: Jun. 12, 2025

(54) SYSTEMS AND METHODS FOR TRANSPARENT OBJECT SEGMENTATION USING POLARIZATION CUES

(71) Applicant: Intrinsic Innovation LLC, Mountain View, CA (US)

(72) Inventors: Agastya Kalra, Palo Alto, CA (US); Vage Taamazyan, Balashika (RU); Supreeth Krishna Rao, San Jose, CA (US); Kartik Venkataraman, San Jose, CA (US); Ramesh Raskar, Cambridge, MA (US); Achuta Kadambi, Los Angeles, CA (US)

(21) Appl. No.: 18/535,338

(22) Filed: Dec. 11, 2023

Related U.S. Application Data
(63) Continuation of application No. 17/689,396, filed on Mar. 8, 2022, now Pat. No. 11,842,495.
Application No. 17/689,396 is a continuation of application No. 17/266,046, filed on Feb. 4, 2021, now Pat. No. 11,302,012.
(60) Provisional application No. 62/942,113, filed on Nov. 30, 2019.
(60) Provisional application No. 63/001,445, filed on Mar. 29, 2020.

(51) Int. Cl. G06V 10/60; B25J 9/16; G06V 10/26; G06V 10/764; G06V 10/77; G06V 10/774; G06V 10/82; G06V 20/50; G06V 20/60

(52) U.S. Cl. CPC G06V 10/60; B25J 9/1697; G06V 10/26; G06V 10/764; G06V 10/7715; G06V 10/774; G06V 10/82; G06V 20/50; G06V 20/60

(57) ABSTRACT

A computer-implemented method for computing a prediction on images of a scene includes: receiving one or more polarization raw frames of a scene, the polarization raw frames being captured with a polarizing filter at a different linear polarization angle; extracting one or more first tensors in one or more polarization representation spaces from the polarization raw frames; and computing a prediction regarding one or more optically challenging objects in the scene based on the one or more first tensors in the one or more polarization representation spaces.

### CROSS-REFERENCE TO RELATED APPLICATION(S)

This application is a continuation of U.S. application Ser. No. 17/689,396, filed on Mar. 8, 2022, which is a continuation of U.S. application Ser. No. 17/266,046, filed on Feb. 4, 2021 (now U.S. Pat. No. 11,302,012), which is a U.S. National Phase Patent Application of International Application Number PCT/US2020/048604, filed on Aug. 28, 2020, which claims priority to and the benefit of U.S. Provisional Application No. 63/001,445, filed on Mar. 29, 2020, and which claims priority to and the benefit of U.S. Provisional Application No. 62/942,113, filed on Nov. 30, 2019. The disclosures of the prior applications are considered part of and are incorporated by reference in the disclosure of this application.

### FIELD

Aspects of embodiments of the present disclosure relate to the field of computer vision and the segmentation of images into distinct objects depicted in the images.

### BACKGROUND

Semantic segmentation refers to a computer vision process of capturing one or more two-dimensional (2-D) images of a scene and algorithmically classifying various regions of the image (e.g., each pixel of the image) as belonging to particular of classes of objects. For example, applying semantic segmentation to an image of people in a garden may assign classes to individual pixels of the input image, where the classes may include types of real-world objects such as: person; animal; tree; ground; sky; rocks; buildings; and the like. Instance segmentation refers to further applying unique labels to each of the different instances of objects, such as by separately labeling each person and each animal in the input image with a different identifier.

One possible output of a semantic segmentation or instance segmentation process is a segmentation map or segmentation mask, which may be a 2-D image having the same dimensions as the input image, and where the value of each pixel corresponds to a label (e.g., a particular class in the case of semantic segmentation or a particular instance in the case of instance segmentation).

Segmentation of images of transparent objects is a difficult, open problem in computer vision. Transparent objects lack texture (e.g., surface color information, such as in “texture mapping” as the term is used in the field of computer graphics), adopting instead the texture or appearance of the scene behind those transparent objects (e.g., the background of the scene visible through the transparent objects). As a result, in some circumstances, transparent objects (and other optically challenging objects) in a captured scene are substantially invisible to the semantic segmentation algorithm, or may be classified based on the objects that are visible through those transparent objects.

### SUMMARY

Aspects of embodiments of the present disclosure relate to transparent object segmentation of images by using light polarization (the rotation of light waves) to provide additional channels of information to the semantic segmentation or other machine vision process. Aspects of embodiments of the present disclosure also relate to detection and/or segmentation of other optically challenging objects in images by using light polarization, where optically challenging objects may exhibit one or more conditions including being: non-Lambertian; translucent; multipath inducing; or non-reflective. In some embodiments, a polarization camera is used to capture polarization raw frames to generate multi-modal imagery (e.g., multi-dimensional polarization information). Some aspects of embodiments of the present disclosure relate to neural network architecture using a deep learning backbone for processing the multi-modal polarization input data. Accordingly, embodiments of the present disclosure reliably perform instance segmentation on cluttered, transparent and otherwise optically challenging objects in various scene and background conditions, thereby demonstrating an improvement over comparative approaches based on intensity images alone.

According to one embodiment of the present disclosure a computer-implemented method for computing a prediction on images of a scene includes: receiving one or more polarization raw frames of a scene, the polarization raw frames being captured with a polarizing filter at a different linear polarization angle; extracting one or more first tensors in one or more polarization representation spaces from the polarization raw frames; and computing a prediction regarding one or more optically challenging objects in the scene based on the one or more first tensors in the one or more polarization representation spaces.

The one or more first tensors in the one or more polarization representation spaces may include: a degree of linear polarization (DOLP) image in a DOLP representation space; and an angle of linear polarization (AOLP) image in an AOLP representation space.

The one or more first tensors may further include one or more non-polarization tensors in one or more non-polarization representation spaces, and the one or more non-polarization tensors may include one or more intensity images in intensity representation space.

The one or more intensity images may include: a first color intensity image; a second color intensity image; and a third color intensity image.

The prediction may include a segmentation mask.

The computing the prediction may include supplying the one or more first tensors to one or more corresponding convolutional neural network (CNN) backbones, and each of the one or more CNN backbones may be configured to compute a plurality of mode tensors at a plurality of different scales.

The computing the prediction may further include: fusing the mode tensors computed at a same scale by the one or more CNN backbones.

The fusing the mode tensors at the same scale may include concatenating the mode tensors at the same scale; supplying the mode tensors to an attention subnetwork to compute one or more attention maps; and weighting the mode tensors based on the one or more attention maps to compute a fused tensor for the scale.

The computing the prediction may further include supplying the fused tensors computed at each scale to a prediction module configured to compute the segmentation mask.

The segmentation mask may be supplied to a controller of a robot picking arm.

The prediction may include a classification of the one or more polarization raw frames based on the one or more optically challenging objects.

The prediction may include one or more detected features of the one or more optically challenging objects depicted in the one or more polarization raw frames.

The computing the prediction may include supplying the one or more first tensors in the one or more polarization representation spaces to a statistical model, and the statistical model may be trained using training data including training first tensors in the one or more polarization representation spaces and labels.

The training data may include: source training first tensors, in the one or more polarization representation spaces, computed from data captured by a polarization camera; and additional training first tensors generated from the source training first tensors through affine transformations including a rotation.

When the additional training first tensors include an angle of linear polarization (AOLP) image, generating the additional training first tensors may include: rotating the additional training first tensors by an angle; and counter-rotating pixel values of the AOLP image by the angle.

According to one embodiment of the present disclosure, a computer vision system includes: a polarization camera including a polarizing filter; and a processing system including a processor and memory storing instructions that, when executed by the processor, cause the processor to: receive one or more polarization raw frames of a scene, the polarization raw frames being captured with a polarizing filter at a different linear polarization angle; extract one or more first tensors in one or more polarization representation spaces from the polarization raw frames; and compute a prediction regarding one or more optically challenging objects in the scene based on the one or more first tensors in the one or more polarization representation spaces.

The one or more first tensors in the one or more polarization representation spaces may include: a degree of linear polarization (DOLP) image in a DOLP representation space; and an angle of linear polarization (AOLP) image in an AOLP representation space.

The one or more first tensors may further include one or more non-polarization tensors in one or more non-polarization representation spaces, and wherein the one or more non-polarization tensors include one or more intensity images in intensity representation space.

The one or more intensity images may include: a first color intensity image; a second color intensity image; and a third color intensity image.

The prediction may include a segmentation mask.

The memory may further store instructions that, when executed by the processor, cause the processor to compute the prediction by supplying the one or more first tensors to one or more corresponding convolutional neural network (CNN) backbones, wherein each of the one or more CNN backbones is configured to compute a plurality of mode tensors at a plurality of different scales.

The memory may further store instructions that, when executed by the processor, cause the processor to: fuse the mode tensors computed at a same scale by the one or more CNN backbones.

The instructions that cause the processor to fuse the mode tensors at the same scale may include instructions that, when executed by the processor, cause the processor to: concatenate the mode tensors at the same scale; supply the mode tensors to an attention subnetwork to compute one or more attention maps; and weight the mode tensors based on the one or more attention maps to compute a fused tensor for the scale.

The instructions that cause the processor to compute the prediction may further include instructions that, when executed by the processor, cause the processor to supply the fused tensors computed at each scale to a prediction module configured to compute the segmentation mask.

The segmentation mask may be supplied to a controller of a robot picking arm.

The prediction may include a classification of the one or more polarization raw frames based on the one or more optically challenging objects.

The prediction may include one or more detected features of the one or more optically challenging objects depicted in the one or more polarization raw frames.

The instructions to compute the prediction may include instructions that, when executed by the processor, cause the processor to supply the one or more first tensors to a statistical model, and the statistical model may be trained using training data including training first tensors in the one or more polarization representation spaces and labels.

The training data may include: source training first tensors computed from data captured by a polarization camera; and additional training first tensors generated from the source training first tensors through affine transformations including a rotation.

When the additional training first tensors include an angle of linear polarization (AOLP) image, generating the additional training first tensors includes: rotating the additional training first tensors by an angle; and counter-rotating pixel values of the AOLP image by the angle.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a schematic block diagram of a system according to one embodiment of the present invention.

FIG. 2A is an image or intensity image of a scene with one real transparent ball placed on top of a printout of photograph depicting another scene containing two transparent balls (“spoofs”) and some background clutter.

FIG. 2B depicts the intensity image of FIG. 2A with an overlaid segmentation mask as computed by a comparative Mask Region-based Convolutional Neural Network (Mask R-CNN) identifying instances of transparent balls, where the real transparent ball is correctly identified as an instance, and the two spoofs are incorrectly identified as instances.

FIG. 2C is an angle of polarization image computed from polarization raw frames captured of the scene according to one embodiment of the present invention.

FIG. 2D depicts the intensity image of FIG. 2A with an overlaid segmentation mask as computed using polarization data in accordance with an embodiment of the present invention, where the real transparent ball is correctly identified as an instance and the two spoofs are correctly excluded as instances.

FIG. 3 is a block diagram of processing circuit for computing segmentation maps based on polarization data according to one embodiment of the present invention.

FIG. 4 is a flowchart of a method for performing segmentation on input images to compute a segmentation map according to one embodiment of the present invention.

FIG. 5 is a high-level depiction of the interaction of light with transparent objects and non-transparent (e.g., diffuse and/or reflective) objects.

FIGS. 6A, 6B, and 6C depict example first feature maps computed by a feature extractor configured to extract derived feature maps in first representation spaces including an intensity feature map/in FIG. 6A in intensity representation space, a degree of linear polarization (DOLP) feature map p in FIG. 6B in DOLP representation space, and angle of linear polarization (AOLP) feature map ¢ in FIG. 6C representation space, according to one embodiment of the present invention.

FIGS. 7A and 7B are, respectively, expanded views of the regions labeled (a) and (b) in FIGS. 6A, 6B, and 6C. FIG. 7C is a graph depicting a cross section of an edge labeled in FIG. 7B in the intensity feature map of FIG. 6A, the DOLP feature map of FIG. 6B, and the AOLP feature map of FIG. 6C.

FIG. 8A is a block diagram of a feature extractor according to one embodiment of the present invention.

FIG. 8B is a flowchart depicting a method according to one embodiment of the present invention for extracting features from polarization raw frames.

FIG. 9 is a block diagram depicting a Polarized CNN architecture according to one embodiment of the present invention as applied to a Mask-Region-based convolutional neural network (Mask R-CNN) backbone.

FIG. 10 is a block diagram of an attention module that may be used with a polarized CNN according to one embodiment of the present invention.

FIG. 11 depicts examples of attention weights computed by an attention module according to one embodiment of the present invention for different mode tensors (in first representation spaces) extracted from polarization raw frames captured by a polarization camera.

FIGS. 12A, 12B, 12C, and 12D depict segmentation maps computed by a comparative image segmentation system, segmentation maps computed by a polarized convolutional neural network according to one embodiment of the present disclosure, and ground truth segmentation maps (e.g., manually-generated segmentation maps).

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. Like reference numerals designate like elements throughout the specification.

Transparent objects occur in many real-world applications of computer vision or machine vision systems, including automation and analysis for manufacturing, life sciences, and automotive industries. For example, in manufacturing, computer vision systems may be used to automate: sorting, selection, and placement of parts; verification of placement of components during manufacturing; and final inspection and defect detection. As additional examples, in life sciences, computer vision systems may be used to automate: measurement of reagents; preparation of samples; reading outputs of instruments; characterization of samples; and picking and placing container samples. Further examples in automotive industries include detecting transparent objects in street scenes for assisting drivers or for operating self-driving vehicles. Additional examples may include assistive technologies, such as self-navigating wheelchairs capable of detecting glass doors and other transparent barriers and devices for assisting people with vision impairment that are capable of detecting transparent drinking glasses and to distinguish between real objects and print-out spoofs.

In contrast to opaque objects, transparent objects lack texture of their own (e.g., surface color information, as the term is used in the field of computer graphics, such as in “texture mapping”). As a result, comparative systems generally fail to correctly identify instances of transparent objects that are present in scenes captured using standard imaging systems (e.g., cameras configured to capture monochrome intensity images or color intensity images such as red, green, and blue or RGB images). This may be because the transparent objects do not have a consistent texture (e.g., surface color) for the algorithms to latch on to or to learn to detect (e.g., during the training process of a machine learning algorithm). Similar issues may arise from partially transparent or translucent objects, as well as some types of reflective objects (e.g., shiny metal) and very dark objects (e.g., matte black objects).

Accordingly, aspects of embodiments of the present disclosure relate to using polarization imaging to provide information for segmentation algorithms to detect transparent objects in scenes. In addition, aspects of embodiments of the present disclosure also apply to detecting other optically challenging objects such as transparent, translucent, and reflective objects as well as dark objects.

As used herein, the term “optically challenging” refers to objects made of materials that satisfy one or more of the following four characteristics at a sufficient threshold level or degree: non-Lambertian (e.g., not matte); translucent; multipath inducing; and/or non-reflective. In some circumstances an object exhibiting only one of the four characteristics may be optically challenging to detect. In addition, objects or materials may exhibit multiple characteristics simultaneously. For example, a translucent object may have a surface reflection and background reflection, so it is challenging both because of translucency and the multipath. In some circumstances, an object may exhibit one or more of the four characteristics listed above, yet may not be optically challenging to detect because these conditions are not exhibited at a level or degree that would pose a problem to a comparative computer vision systems. For example, an object may be translucent, but still exhibit enough surface texture to be detectable and segmented from other instances of objects in a scene. As another example, a surface must be sufficiently non-Lambertian to introduce problems to other vision systems. In some embodiments, the degree or level to which an object is optically challenging is quantified using the full-width half max (FWHM) of the specular lobe of the bidirectional reflectance distribution function (BRDF) of the object. If this FWHM is below a threshold, the material is considered optically challenging.

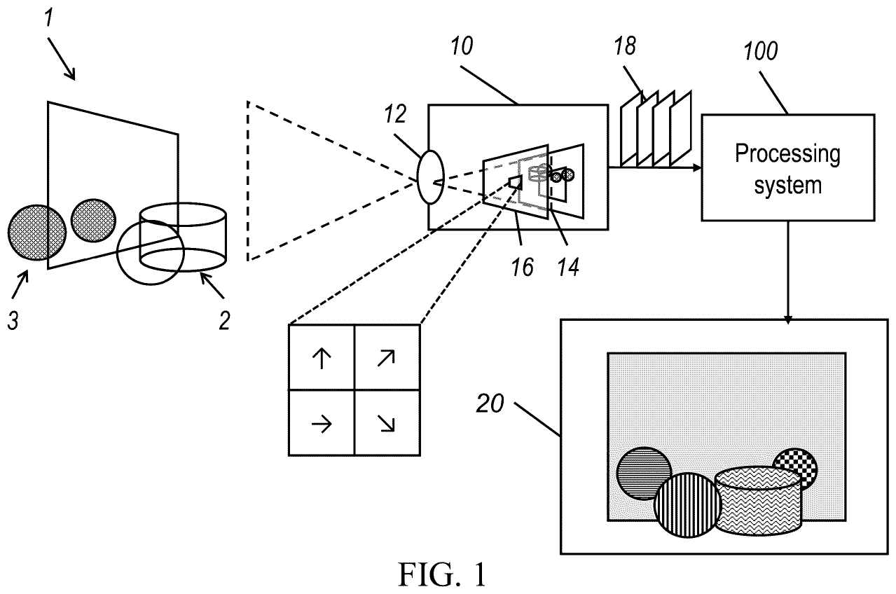

FIG. 1 is a schematic block diagram of a system according to one embodiment of the present invention. In the arrangement shown in FIG. 1, a scene 1 includes transparent objects 2 (e.g., depicted as a ball such as a glass marble, a cylinder such as a drinking glass or tumbler, and a plane such as a pane of transparent acrylic) that are placed in front of opaque matte objects 3 (e.g., a baseball and a tennis ball). A polarization camera 10 has a lens 12 with a field of view, where the lens 12 and the camera 10 are oriented such that the field of view encompasses the scene 1. The lens 12 is configured to direct light (e.g., focus light) from the scene 1 onto a light sensitive medium such as an image sensor 14 (e.g., a complementary metal oxide semiconductor (CMOS) image sensor or charge-coupled device (CCD) image sensor).

The polarization camera 10 further includes a polarizer or polarizing filter or polarization mask 16 placed in the optical path between the scene 1 and the image sensor 14. According to various embodiments of the present disclosure, the polarizer or polarization mask 16 is configured to enable the polarization camera 10 to capture images of the scene 1 with the polarizer set at various specified angles (e.g., at 45° rotations or at 60° rotations or at non-uniformly spaced rotations).

As one example, FIG. 1 depicts an embodiment where the polarization mask 16 is a polarization mosaic aligned with the pixel grid of the image sensor 14 in a manner similar to a red-green-blue (RGB) color filter (e.g., a Bayer filter) of a color camera. In a manner similar to how a color filter mosaic filters incoming light based on wavelength such that each pixel in the image sensor 14 receives light in a particular portion of the spectrum (e.g., red, green, or blue) in accordance with the pattern of color filters of the mosaic, a polarization mask 16 using a polarization mosaic filters light based on linear polarization such that different pixels receive light at different angles of linear polarization (e.g., at 0°, 45°, 90°, and 135°, or at 0°, 60° degrees, and) 120°. Accordingly, the polarization camera 10 using a polarization mask 16 such as that shown in FIG. 1 is capable of concurrently or simultaneously capturing light at four different linear polarizations. One example of a polarization camera is the Blackfly® S Polarization Camera produced by FLIR® Systems, Inc. of Wilsonville, Oregon.

While the above description relates to some possible implementations of a polarization camera using a polarization mosaic, embodiments of the present disclosure are not limited thereto and encompass other types of polarization cameras that are capable of capturing images at multiple different polarizations. For example, the polarization mask 16 may have fewer than or more than four different polarizations, or may have polarizations at different angles (e.g., at angles of polarization of: 0°, 60° degrees, and 120° or at angles of polarization of 0°, 30°, 60°, 90°, 120°, and) 150°. As another example, the polarization mask 16 may be implemented using an electronically controlled polarization mask, such as an electro-optic modulator (e.g., may include a liquid crystal layer), where the polarization angles of the individual pixels of the mask may be independently controlled, such that different portions of the image sensor 14 receive light having different polarizations. As another example, the electro-optic modulator may be configured to transmit light of different linear polarizations when capturing different frames, e.g., so that the camera captures images with the entirety of the polarization mask set to, sequentially, to different linear polarizer angles (e.g., sequentially set to: 0 degrees; 45 degrees; 90 degrees; or 135 degrees). As another example, the polarization mask 16 may include a polarizing filter that rotates mechanically, such that different polarization raw frames are captured by the polarization camera 10 with the polarizing filter mechanically rotated with respect to the lens 12 to transmit light at different angles of polarization to image sensor 14.

As a result, the polarization camera captures multiple input images 18 (or polarization raw frames) of the scene 1, where each of the polarization raw frames 18 corresponds to an image taken behind a polarization filter or polarizer at a different angle of polarization @pol (e.g., 0 degrees, 45 degrees, 90 degrees, or 135 degrees). Each of the polarization raw frames is captured from substantially the same pose with respect to the scene 1 (e.g., the images captured with the polarization filter at 0 degrees, 45 degrees, 90 degrees, or 135 degrees are all captured by a same polarization camera located at a same location and orientation), as opposed to capturing the polarization raw frames from disparate locations and orientations with respect to the scene. The polarization camera 10 may be configured to detect light in a variety of different portions of the electromagnetic spectrum, such as the human-visible portion of the electromagnetic spectrum, red, green, and blue portions of the human-visible spectrum, as well as invisible portions of the electromagnetic spectrum such as infrared and ultraviolet.

In some embodiments of the present disclosure, such as some of the embodiments described above, the different polarization raw frames are captured by a same polarization camera 10 and therefore may be captured from substantially the same pose (e.g., position and orientation) with respect to the scene 1. However, embodiments of the present disclosure are not limited thereto. For example, a polarization camera 10 may move with respect to the scene 1 between different polarization raw frames (e.g., when different raw polarization raw frames corresponding to different angles of polarization are captured at different times, such as in the case of a mechanically rotating polarizing filter), either because the polarization camera 10 has moved or because objects in the scene 1 have moved (e.g., if the objects are located on a moving conveyor belt). Accordingly, in some embodiments of the present disclosure different polarization raw frames are captured with the polarization camera 10 at different poses with respect to the scene 1.

The polarization raw frames 18 are supplied to a processing circuit 100, described in more detail below, computes a segmentation map 20 based of the polarization raw frames 18. As shown in FIG. 1, in the segmentation map 20, the transparent objects 2 and the opaque objects 3 of the scene are all individually labeled, where the labels are depicted in FIG. 1 using different colors or patterns (e.g., vertical lines, horizontal lines, checker patterns, etc.), but where, in practice, each label may be represented by a different value (e.g., an integer value, where the different patterns shown in the figures correspond to different values) in the segmentation map.

According to various embodiments of the present disclosure, the processing circuit 100 is implemented using one or more electronic circuits configured to perform various operations as described in more detail below. Types of electronic circuits may include a central processing unit (CPU), a graphics processing unit (GPU), an artificial intelligence (AI) accelerator (e.g., a vector processor, which may include vector arithmetic logic units configured efficiently perform operations common to neural networks, such dot products and softmax), a field programmable gate array (FPGA), an application specific integrated circuit (ASIC), a digital signal processor (DSP), or the like. For example, in some circumstances, aspects of embodiments of the present disclosure are implemented in program instructions that are stored in a non-volatile computer readable memory where, when executed by the electronic circuit (e.g., a CPU, a GPU, an AI accelerator, or combinations thereof), perform the operations described herein to compute a segmentation map 20 from input polarization raw frames 18. The operations performed by the processing circuit 100 may be performed by a single electronic circuit (e.g., a single CPU, a single GPU, or the like) or may be allocated between multiple electronic circuits (e.g., multiple GPUs or a CPU in conjunction with a GPU). The multiple electronic circuits may be local to one another (e.g., located on a same die, located within a same package, or located within a same embedded device or computer system) and/or may be remote from one other (e.g., in communication over a network such as a local personal area network such as Bluetooth®, over a local area network such as a local wired and/or wireless network, and/or over wide area network such as the internet, such a case where some operations are performed locally and other operations are performed on a server hosted by a cloud computing service). One or more electronic circuits operating to implement the processing circuit 100 may be referred to herein as a computer or a computer system, which may include memory storing instructions that, when executed by the one or more electronic circuits, implement the systems and methods described herein.

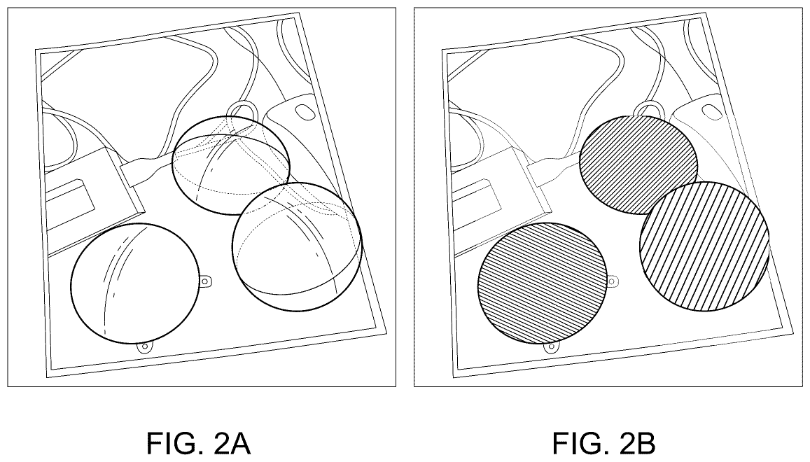

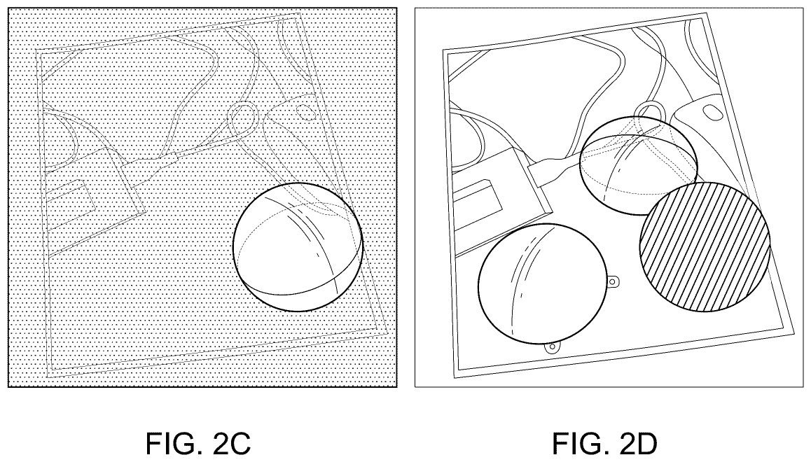

FIGS. 2A, 2B, 2C, and 2D provide background for illustrating the segmentation maps computed by a comparative approach and semantic segmentation or instance segmentation according to embodiments of the present disclosure. In more detail, FIG. 2A is an image or intensity image of a scene with one real transparent ball placed on top of a printout of photograph depicting another scene containing two transparent balls (“spoofs”) and some background clutter. FIG. 2B depicts an segmentation mask as computed by a comparative Mask Region-based Convolutional Neural Network (Mask R-CNN) identifying instances of transparent balls overlaid on the intensity image of FIG. 2A using different patterns of lines, where the real transparent ball is correctly identified as an instance, and the two spoofs are incorrectly identified as instances. In other words, the Mask R-CNN algorithm has been fooled into labeling the two spoof transparent balls as instances of actual transparent balls in the scene.

FIG. 2C is an angle of linear polarization (AOLP) image computed from polarization raw frames captured of the scene according to one embodiment of the present invention. As shown in FIG. 2C, transparent objects have a very unique texture in polarization space such as the AOLP domain, where there is a geometry-dependent signature on edges and a distinct or unique or particular pattern that arises on the surfaces of transparent objects in the angle of linear polarization. In other words, the intrinsic texture of the transparent object (e.g., as opposed to extrinsic texture adopted from the background surfaces visible through the transparent object) is more visible in the angle of polarization image of FIG. 2C than it is in the intensity image of FIG. 2A.

FIG. 2D depicts the intensity image of FIG. 2A with an overlaid segmentation mask as computed using polarization data in accordance with an embodiment of the present invention, where the real transparent ball is correctly identified as an instance using an overlaid pattern of lines and the two spoofs are correctly excluded as instances (e.g., in contrast to FIG. 2B, FIG. 2D does not include overlaid patterns of lines over the two spoofs). While FIGS. 2A, 2B, 2C, and 2D illustrate an example relating to detecting a real transparent object in the presence of spoof transparent objects, embodiments of the present disclosure are not limited thereto and may also be applied to other optically challenging objects, such as transparent, translucent, and non-matte or non-Lambertian objects, as well as non-reflective (e.g., matte black objects) and multipath inducing objects.

Accordingly, some aspects of embodiments of the present disclosure relate to extracting, from the polarization raw frames, tensors in representation space (or first tensors in first representation spaces, such as polarization feature maps) to be supplied as input to semantic segmentation algorithms or other computer vision algorithms. These first tensors in first representation space may include polarization feature maps that encode information relating to the polarization of light received from the scene such as the AOLP image shown in FIG. 2C, degree of linear polarization (DOLP) feature maps, and the like (e.g., other combinations from Stokes vectors or transformations of individual ones of the polarization raw frames). In some embodiments, these polarization feature maps are used together with non-polarization feature maps (e.g., intensity images such as the image shown in FIG. 2A) to provide additional channels of information for use by semantic segmentation algorithms.

While embodiments of the present invention are not limited to use with particular semantic segmentation algorithms, some aspects of embodiments of the present invention relate to deep learning frameworks for polarization-based segmentation of transparent or other optically challenging objects (e.g., transparent, translucent, non-Lambertian, multipath inducing objects, and non-reflective (e.g., very dark) objects), where these frameworks may be referred to as Polarized Convolutional Neural Networks (Polarized CNNs). This Polarized CNN framework includes a backbone that is suitable for processing the particular texture of polarization and can be coupled with other computer vision architectures such as Mask R-CNN (e.g., to form a Polarized Mask R-CNN architecture) to produce a solution for accurate and robust instance segmentation of transparent objects. Furthermore, this approach may be applied to scenes with a mix of transparent and non-transparent (e.g., opaque objects) and can be used to identify instances of transparent, translucent, non-Lambertian, multipath inducing, dark, and opaque objects in the scene.

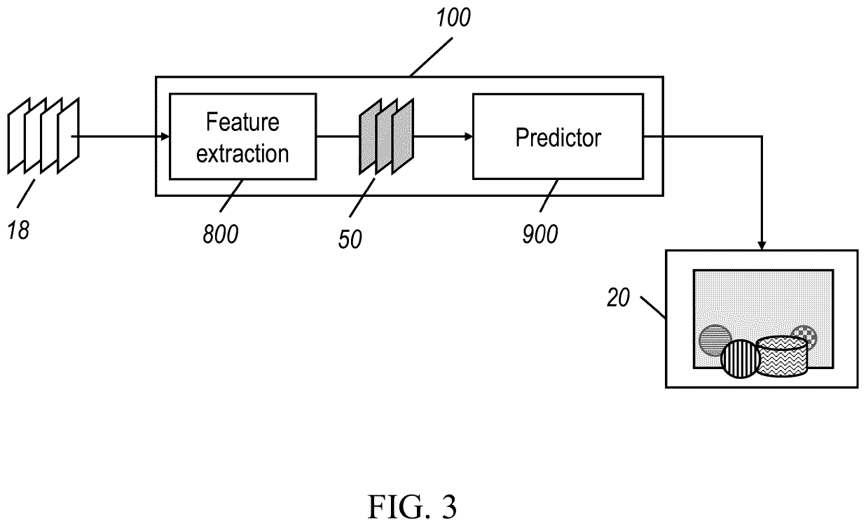

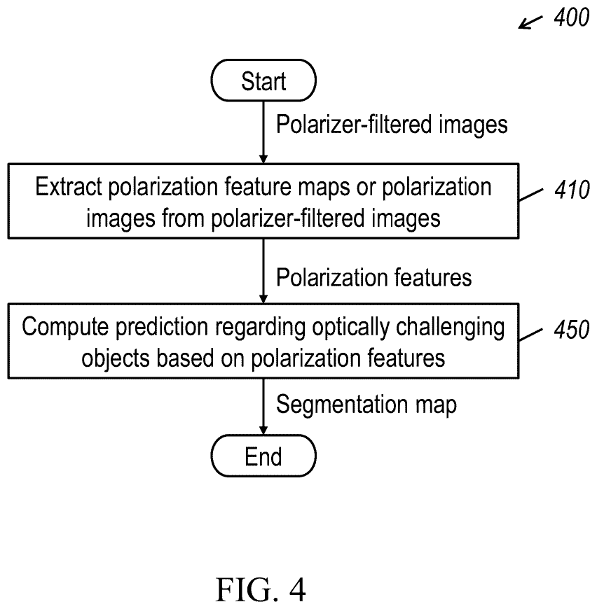

FIG. 3 is a block diagram of processing circuit 100 for computing segmentation maps based on polarization data according to one embodiment of the present invention. FIG. 4 is a flowchart of a method for performing segmentation on input images to compute a segmentation map according to one embodiment of the present invention. As shown in FIG. 3, in some embodiments, a processing circuit 100 includes a feature extractor or feature extraction system 800 and a predictor 900 (e.g., a classical computer vision prediction algorithm or a trained statistical model) configured to compute a prediction output 20 (e.g., a statistical prediction) regarding one or more transparent objects in the scene based on the output of the feature extraction system 800. While some embodiments of the present disclosure are described herein in the context of training a system for detecting transparent objects, embodiments of the present disclosure are not limited thereto, and may also be applied to techniques for other optically challenging objects or objects made of materials that are optically challenging to detect such as translucent objects, multipath inducing objects, objects that are not entirely or substantially matte or Lambertian, and/or very dark objects. These optically challenging objects include objects that are difficult to resolve or detect through the use of images that are capture by camera systems that are not sensitive to the polarization of light (e.g., based on images captured by cameras without a polarizing filter in the optical path or where different images do not capture images based on different polarization angles).

In the embodiment shown in FIGS. 3 and 4, in operation 410, the feature extraction system 800 of the processing system 100 extracts one or more first feature maps 50 in one or more first representation spaces (including polarization images or polarization feature maps in various polarization representation spaces) from the input polarization raw frames 18 of a scene. The extracted derived feature maps 50 (including polarization images) are provided as input to the predictor 900 of the processing system 100, which implements one or more prediction models to compute, in operation 450, a detected output 20. In the case where the predictor is an image segmentation or instance segmentation system, the prediction may be a segmentation map such as that shown in FIG. 3, where each pixel may be associated with one or more confidences that the pixel corresponds to various possible classes (or types) of objects. In the case where the predictor is a classification system, the prediction may include a plurality of classes and corresponding confidences that the image depicts an instance of each of the classes. In the case where the predictor 900 is a classical computer vision prediction algorithm, the predictor may compute a detection result (e.g., detect edges, keypoints, basis coefficients, Haar wavelet coefficients, or other features of transparent objects and/or other optically challenging objects, such as translucent objects, multipath inducing objects, non-Lambertian objects, and non-reflective objects in the image as output features).

In the embodiment shown in FIG. 3, the predictor 900 implements an instance segmentation (or a semantic segmentation) system and computes, in operation 450, an output 20 that includes a segmentation map for the scene based on the extracted first tensors 50 in first representation spaces, extracted from the input polarization raw frames 18. As noted above the feature extraction system 800 and the predictor 900 are implemented using one or more electronic circuits that are configured to perform their operations, as described in more detail below.

Extracting First Tensors Such as Polarization Images and Derived Feature Maps in First Representation Spaces from Polarization Raw Frames

Some aspects of embodiments of the present disclosure relate to systems and methods for extracting features in operation 410, where these extracted features are used in the robust detection of transparent objects in operation 450. In contrast, comparative techniques relying on intensity images alone may fail to detect transparent objects (e.g., comparing the intensity image of FIG. 2A with the AOLP image of FIG. 2C, discussed above). The term “first tensors” in “first representation spaces” will be used herein to refer to features computed from (e.g., extracted from) polarization raw frames 18 captured by a polarization camera, where these first representation spaces include at least polarization feature spaces (e.g., feature spaces such as AOLP and DOLP that contain information about the polarization of the light detected by the image sensor) and may also include non-polarization feature spaces (e.g., feature spaces that do not require information regarding the polarization of light reaching the image sensor, such as images computed based solely on intensity images captured without any polarizing filters).

The interaction between light and transparent objects is rich and complex, but the material of an object determines its transparency under visible light. For many transparent household objects, the majority of visible light passes straight through and a small portion (˜4% to ˜8%, depending on the refractive index) is reflected. This is because light in the visible portion of the spectrum has insufficient in energy to excite atoms in the transparent object. As a result, the texture (e.g., appearance) of objects behind the transparent object (or visible through the transparent object) dominate the appearance of the transparent object. For example, when looking at a transparent glass cup or tumbler on a table, the appearance of the objects on the other side of the tumbler (e.g., the surface of the table) generally dominate what is seen through the cup. This property leads to some difficulties when attempting instance segmentation based on intensity images alone:

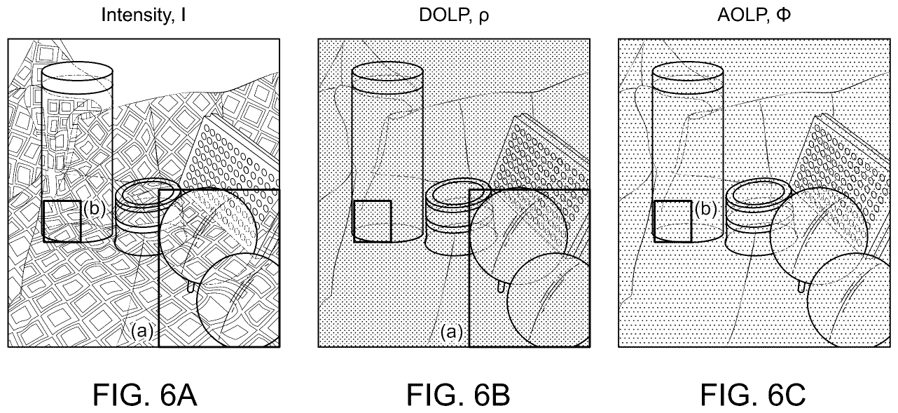

Clutter: Clear edges (e.g., the edges of transparent objects) are hard to see in densely cluttered scenes with transparent objects. In extreme cases, the edges are not visible at all (see, e.g., region (b) of FIG. 6A, described in more detail below), creating ambiguities in the exact shape of the transparent objects.

Novel Environments: Low reflectivity in the visible spectrum causes transparent objects to appear different, out-of-distribution, in novel environments (e.g., environments different from the training data used to train the segmentation system, such as where the backgrounds visible through the transparent objects differ from the backgrounds in the training data), thereby leading to poor generalization.

Print-Out Spoofs: algorithms using single RGB images as input are generally susceptible to print-out spoofs (e.g., printouts of photographic images) due to the perspective ambiguity. While other non-monocular algorithms (e.g., using images captured from multiple different poses around the scene, such as a stereo camera) for semantic segmentation of transparent objects exist, they are range limited and may be unable to handle instance segmentation.

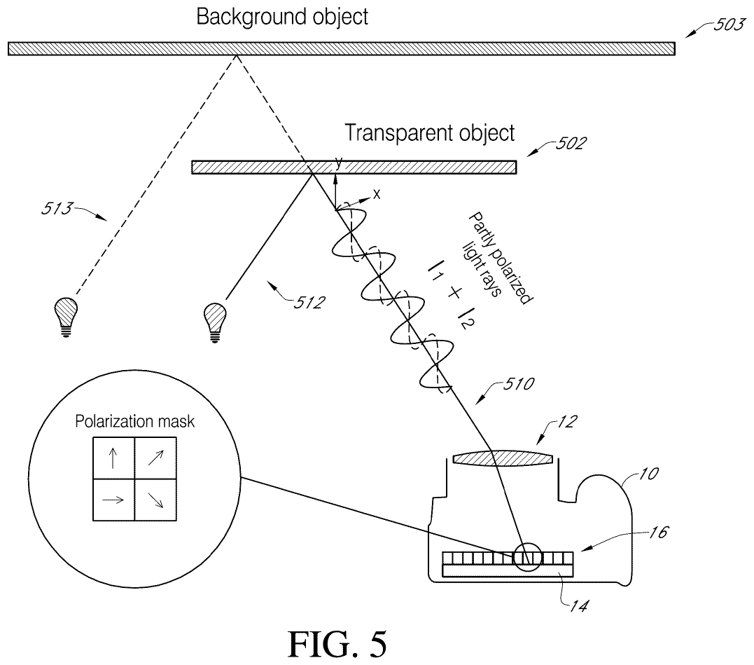

FIG. 5 is a high-level depiction of the interaction of light with transparent objects and non-transparent (e.g., diffuse and/or reflective) objects. As shown in FIG. 5, a polarization camera 10 captures polarization raw frames of a scene that includes a transparent object 502 in front of an opaque background object 503. A light ray 510 hitting the image sensor 14 of the polarization camera 10 contains polarization information from both the transparent object 502 and the background object 503. The small fraction of reflected light 512 from the transparent object 502 is heavily polarized, and thus has a large impact on the polarization measurement, on contrast to the light 513 reflected off the background object 503 and passing through the transparent object 502.

A light ray 510 hitting the image sensor 16 of a polarization camera 10 has three measurable components: the intensity of light (intensity image//), the percentage or proportion of light that is linearly polarized (degree of linear polarization/DOLP/p), and the direction of that linear polarization (angle of linear polarization/AOLP/¢). These properties encode information about the surface curvature and material of the object being imaged, which can be used by the predictor 900 to detect transparent objects, as described in more detail below. In some embodiments, the predictor 900 can detect other optically challenging objects based on similar polarization properties of light passing through translucent objects and/or light interacting with multipath inducing objects or by non-reflective objects (e.g., matte black objects).

Therefore, some aspects of embodiments of the present invention relate to using a feature extractor 800 to compute first tensors in one or more first representation spaces, which may include derived feature maps based on the intensity I, the DOLP ρ, and the AOLP ϕ. The feature extractor 800 may generally extract information into first representation spaces (or first feature spaces) which include polarization representation spaces (or polarization feature spaces) such as “polarization images,” in other words, images that are extracted based on the polarization raw frames that would not otherwise be computable from intensity images (e.g., images captured by a camera that did not include a polarizing filter or other mechanism for detecting the polarization of light reaching its image sensor), where these polarization images may include DOLP ρ images (in DOLP representation space or feature space), AOLP ϕ images (in AOLP representation space or feature space), other combinations of the polarization raw frames as computed from Stokes vectors, as well as other images (or more generally first tensors or first feature tensors) of information computed from polarization raw frames. The first representation spaces may include non-polarization representation spaces such as the intensity/representation space.

Measuring intensity I, DOLP ρ, and AOLP ϕ at each pixel requires 3 or more polarization raw frames of a scene taken behind polarizing filters (or polarizers) at different angles, ϕₚₒₗ (e.g., because there are three unknown values to be determined: intensity I, DOLP ρ, and AOLP ϕ. For example, the FLIR® Blackfly® S Polarization Camera described above captures polarization raw frames with polarization angles ϕₚₒₗ at 0 degrees, 45 degrees, 90 degrees, or 135 degrees, thereby producing four polarization raw frames I_{ϕ}_{ₚₒₗ}_{′} denoted herein as I₀, I₄₅, I₉₀, and/I₃₅.

The relationship between I_{ϕ}_{ₚₒₗ} and intensity I, DOLP ρ, and AOLP Ø at each pixel can be expressed as:

$${I}_{{ϕ}_{pol}} = I ( 1 + ρ cos ( 2 ( ϕ - {ϕ}_{pol} ) ) ) \qquad ( 1 )$$

Accordingly, with four different polarization raw frames I_{ϕ}_{ₚₒₗ} (I₀, I₄₅, I₉₀, and I₁₃₅), a system of four equations can be used to solve for the intensity I, DOLP ρ, and AOLP ϕ.

Shape from Polarization (SfP) theory (see, e.g., Gary A Atkinson and Edwin R Hancock. Recovery of surface orientation from diffuse polarization. IEEE transactions on image processing, 15(6):1653-1664, 2006.) states that the relationship between the refractive index (n), azimuth angle (θₐ) and zenith angle (θ_{z}) of the surface normal of an object and the ϕ and ρ components of the light ray coming from that object.

When diffuse reflection is dominant:

$$ρ = \frac{{( n - \frac{1}{n} )}^{2} {sin}^{2} ( {θ}_{z} )}{2 + 2 {n}^{2} - {( n + \frac{1}{n} )}^{2} {sin}^{2} {θ}_{z} + 4 cos {θ}_{z} \sqrt{{n}^{2} - {sin}^{2} {θ}_{z}}} \qquad ( 2 )$$

$$ϕ = {θ}_{a} \qquad ( 3 )$$

and when the specular reflection is dominant:

$$ρ = \frac{2 {sin}^{2} {θ}_{z} cos {θ}_{z} \sqrt{{n}^{2} - {sin}^{2} {θ}_{z}}}{{n}^{2} - {sin}^{2} {θ}_{z} - {n}^{2} {sin}^{2} {θ}_{z} + 2 {sin}^{4} {θ}_{z}} \qquad ( 4 )$$

$$ϕ = {θ}_{a} - \frac{π}{2} \qquad ( 5 )$$

Note that in both cases ρ increases exponentially as θ_{z} increases and if the refractive index is the same, specular reflection is much more polarized than diffuse reflection.

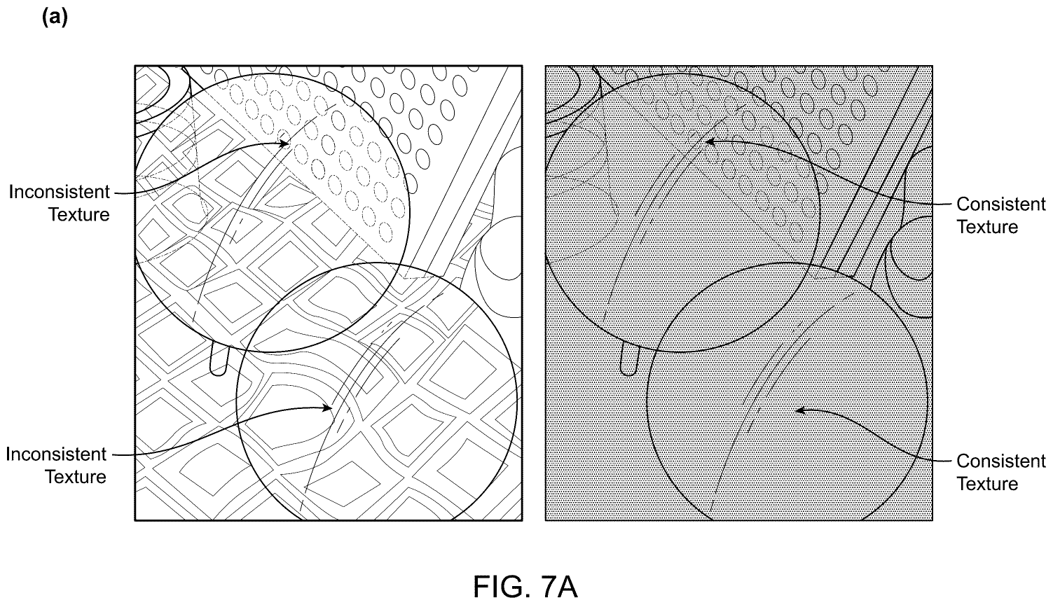

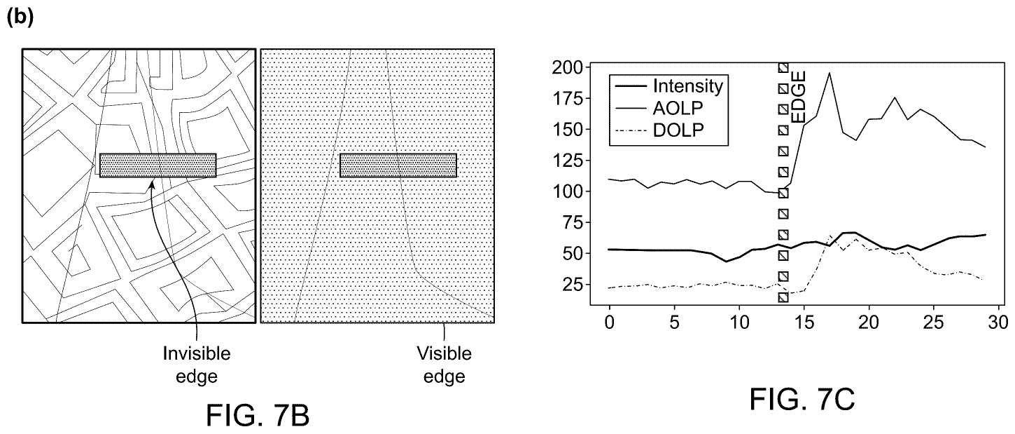

Some aspects of embodiments of the present disclosure relate to supplying first tensors in the first representation spaces (e.g., derived feature maps) extracted from polarization raw frames as inputs to a predictor for computing computer vision predictions on transparent objects and/or other optically challenging objects (e.g., translucent objects, non-Lambertian objects, multipath inducing objects, and/or non-reflective objects) of the scene, such as a semantic segmentation system for computing segmentation maps including the detection of instances of transparent objects and other optically challenging objects in the scene. These first tensors may include derived feature maps which may include an intensity feature map I, a degree of linear polarization (DOLP) ρ feature map, and an angle of linear polarization (AOLP) ϕ feature map, and where the DOLP ρ feature map and the AOLP ϕ feature map are examples of polarization feature maps or tensors in polarization representation spaces, in reference to feature maps that encode information regarding the polarization of light detected by a polarization camera. Benefits of polarization feature maps (or polarization images) are illustrated in more detail with respect to FIGS. 6A, 6B, 6C, 7A, 7B, and 7C.

FIGS. 6A, 6B, and 6C depict example first tensors that are feature maps computed by a feature extractor configured to extract first tensors in first representation spaces including an intensity feature map I in FIG. 6A in intensity representation space, a degree of linear polarization (DOLP) feature map ρ in FIG. 6B in DOLP representation space, and angle of linear polarization (AOLP) feature map ϕ in FIG. 6C in AOLP representation space, according to one embodiment of the present invention. Two regions of interest—region (a) containing two transparent balls and region (b) containing the edge of a drinking glass—are discussed in more detail below.

FIGS. 7A and 7B are, respectively, expanded views of the regions labeled (a) and (b) in FIGS. 6A, 6B, and 6C. FIG. 7C is a graph depicting a cross section of an edge labeled in FIG. 7B in the intensity feature map I of FIG. 6A, the DOLP feature map ρ of FIG. 6B, and the AOLP feature map ϕ of FIG. 6C.

Referring to region (a), as seen in FIG. 6A and the left side of FIG. 7A, the texture of the two transparent balls is inconsistent in the intensity image due to the change in background (e.g., the plastic box with a grid of holes versus the patterned cloth that the transparent balls are resting on), highlighting problems caused by novel environments (e.g., various backgrounds visible through the transparent objects). This inconsistency may make it difficult for a semantic segmentation or instance segmentation system to recognize that these very different-looking parts of the image correspond to the same type or class of object (e.g., a transparent ball).

On the other hand, in the DOLP image shown in FIG. 6B and the right side of FIG. 7A, the shape of the transparent objects is readily apparent and the background texture (e.g., the pattern of the cloth) does not appear in the DOLP image p. FIG. 7A is an enlarged view of region (a) of the intensity image/shown in FIG. 6A and the DOLP image p shown in FIG. 6B, showing that two different portions of the transparent balls have inconsistent (e.g., different-looking) textures in the intensity image/but have consistent (e.g., similar looking) textures in the DOLP image p, thereby making it more likely for a semantic segmentation or instance segmentation system to recognize that these two similar looking textures both correspond to the same class of object, based on the DOLP image p.

Referring region (b), as seen in FIG. 6A and the left side of FIG. 7B, the edge of the drinking glass is practically invisible in the intensity image/(e.g., indistinguishable from the patterned cloth), but is much brighter in the AOLP image ϕ as seen in FIG. 6C and the right side of FIG. 7B. FIG. 7C is a cross-section of the edge in the region identified boxes in the intensity image I and the AOLP image ϕ in FIG. 7B shows that the edge has much higher contrast in the AOLP ϕ and DOLP ρ than in the intensity image I, thereby making it more likely for a semantic segmentation or instance segmentation system to detect the edge of the transparent image, based on the AOLP ϕ and DOLP ρ images.

More formally, aspects of embodiments of the present disclosure relate to computing first tensors 50 in first representation spaces, including extracting first tensors in polarization representation spaces such as forming polarization images (or extracting derived polarization feature maps) in operation 410 based on polarization raw frames captured by a polarization camera 10.

Light rays coming from a transparent objects have two components: a reflected portion including reflected intensity Iᵣ, reflected DOLP ρᵣ, and reflected AOLP ϕᵣ and the refracted portion including refracted intensity Iₜ, refracted DOLP ρₜ, and refracted AOLP ϕₜ. The intensity of a single pixel in the resulting image can be written as:

$$I = {I}_{r} + {I}_{t} \qquad ( 6 )$$

When a polarizing filter having a linear polarization angle of ϕₚₒₗ is placed in front of the camera, the value at a given pixel is:

$${I}_{{ϕ}_{pol}} = {I}_{r} ( 1 + {ρ}_{r} cos ( 2 ( {ϕ}_{r} - {ϕ}_{pol} ) ) ) + {I}_{t} ( 1 + {ρ}_{t} cos ( 2 ( {ϕ}_{t} - {ϕ}_{pol} ) ) ) \qquad ( 7 )$$

Solving the above expression for the values of a pixel in a DOLP ρ image and a pixel in an AOLP ϕ image in terms of Iᵣ, ρᵣ, ϕᵣ, Iₜ, ρₜ, and ϕₜ:

$$ρ = \frac{\sqrt{{( {I}_{r} {ρ}_{r} )}^{2} + {( {I}_{t} {ρ}_{t} )}^{2} + 2 {I}_{t} {ρ}_{t} {I}_{r} {ρ}_{r} cos ( 2 ( {ϕ}_{r} - {ϕ}_{t} ) )}}{{I}_{r} + {I}_{t}} \qquad ( 8 )$$

$$ϕ = arctan ( \frac{{I}_{r} {ρ}_{r} sin ( 2 ( {ϕ}_{r} - {ϕ}_{t} ) )}{{I}_{t} {ρ}_{t} + {I}_{r} {ρ}_{r} cos ( 2 ( {ϕ}_{r} - {ϕ}_{t} ) )} ) + {ϕ}_{r} \qquad ( 9 )$$

Accordingly, equations (7), (8), and (9), above provide a model for forming first tensors 50 in first representation spaces that include an intensity image I, a DOLP image ρ, and an AOLP image ϕ according to one embodiment of the present disclosure, where the use of polarization images or tensor in polarization representation spaces (including DOLP image p and an AOLP image ϕ based on equations (8) and (9)) enables the reliable detection of transparent objects and other optically challenging objects that are generally not detectable by comparative systems such as a Mask R-CNN system, which uses only intensity/images as input.

In more detail, first tensors in polarization representation spaces (among the derived feature maps 50) such as the polarization images DOLP ρ and AOLP ϕ can reveal surface texture of objects that might otherwise appear textureless in an intensity I domain. A transparent object may have a texture that is invisible in the intensity domain/because this intensity is strictly dependent on the ratio of Iᵣ/Iₜ (see equation (6)). Unlike opaque objects where Iₜ=0, transparent objects transmit most of the incident light and only reflect a small portion of this incident light.

On the other hand, in the domain or realm of polarization, the strength of the surface texture of a transparent object depends on ϕᵣ−ϕₜ and the ratio of Iᵣρᵣ/IₜΣₜ (see equations (8) and (9)). Assuming that ϕᵣ≠ϕₜ and θ_{zr}≠θ_{zt} for the majority of pixels (e.g., assuming that the geometries of the background and transparent object are different) and based on showings that ρᵣ follows the specular reflection curve (see, e.g., Daisuke Miyazaki, Masataka Kagesawa, and Katsushi Ikeuchi. Transparent surface modeling from a pair of polarization images. IEEE Transactions on Pattern Analysis & Machine Intelligence, (1):73-82, 2004.), meaning it is highly polarized, and at Brewster's angle (approx.) 60° ρᵣ is 1.0 (see equation (4)), then, at appropriate zenith angles, ρᵣ≥ ρₜ, and, if the background is diffuse or has a low zenith angle, ρᵣ>>ρₜ. This effect can be seen in FIG. 2C, where the texture of the real transparent sphere dominates when θ_{z}≈60°. Accordingly, in many cases, the following assumption holds:

$$\frac{{I}_{r}}{{I}_{t}} \leq \frac{{I}_{r} {ρ}_{r}}{{I}_{t} {ρ}_{t}} \qquad ( 10 )$$

Thus, even if the texture of the transparent object appears invisible in the intensity domain I, the texture of the transparent object may be more visible in the polarization domain, such as in the AOLP ϕ and in the DOLP ρ.

Returning to the three examples of circumstances that lead to difficulties when attempting semantic segmentation or instance segmentation on intensity images alone:

Clutter: One problem in clutter is in detecting the edges of a transparent object that may be substantially texture-less (see, e.g., the edge of the drinking glass in region (b) of FIG. 6A. On the other hand, the texture of the glass and its edges appear more visible in the DOLP ρ shown in FIG. 6B and even more visible in the AOLP Ø shown in FIG. 6C.

Novel environments: In addition to increasing the strength of the transparent object texture, the DOLP ρ image shown, for example, in FIG. 6B, also reduces the impact of diffuse backgrounds like textured or patterned cloth (e.g., the background cloth is rendered almost entirely black). This allows transparent objects to appear similar in different scenes, even when the environment changes from scene-to-scene. See, e.g., region (a) in FIG. 6B and FIG. 7A.

Print-out spoofs: Paper is flat, leading to a mostly uniform AOLP ϕ and DOLP ρ. Transparent objects have some amount of surface variation, which will appear very non-uniform in AOLP ϕ and DOLP ρ (see, e.g. FIG. 2C). As such, print-out spoofs of transparent objects can be distinguished from real transparent objects.

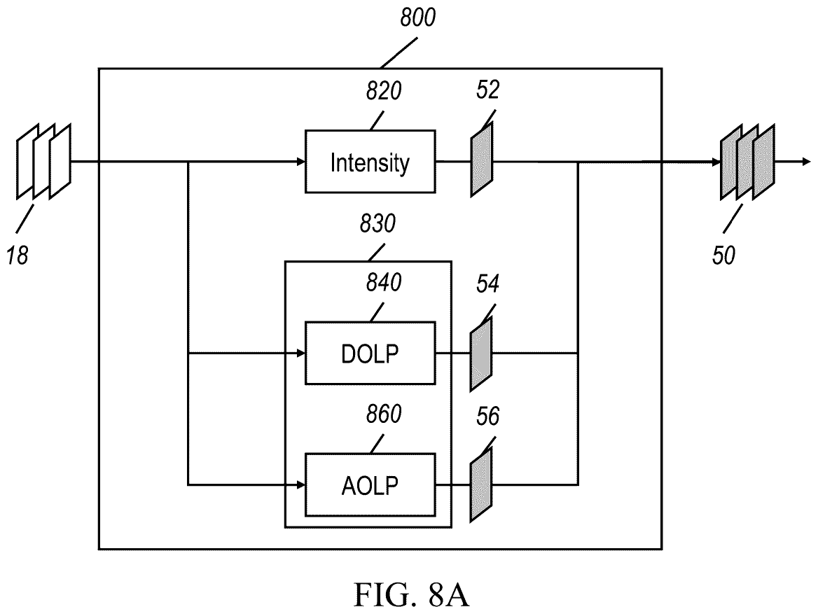

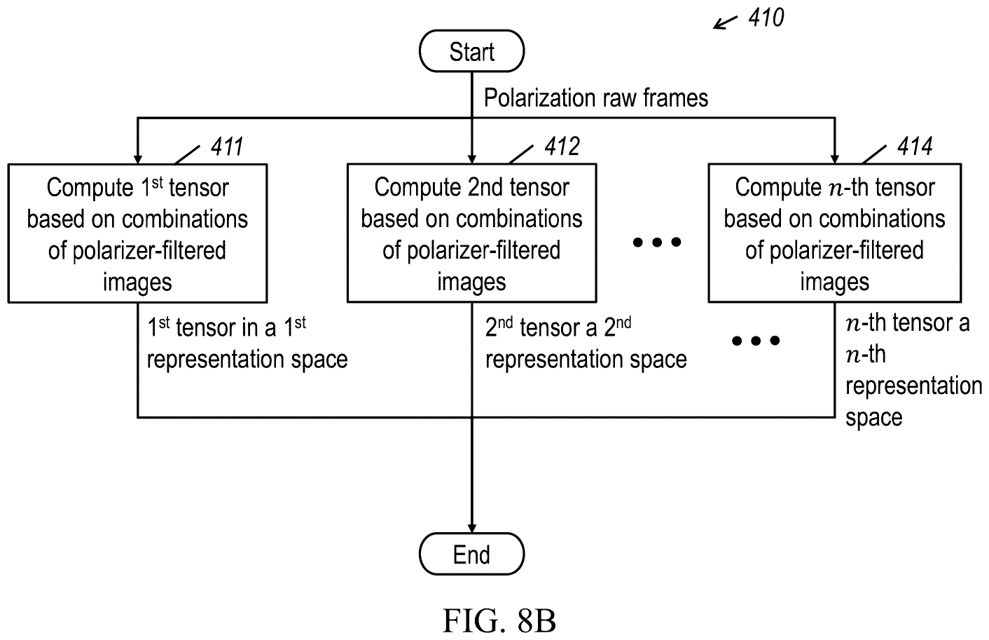

FIG. 8A is a block diagram of a feature extractor 800 according to one embodiment of the present invention. FIG. 8B is a flowchart depicting a method according to one embodiment of the present invention for extracting features from polarization raw frames. In the embodiment shown in FIG. 8A, the feature extractor 800 includes an intensity extractor 820 configured to extract an intensity image I 52 in an intensity representation space (e.g., in accordance with equation (7), as one example of a non-polarization representation space) and polarization feature extractors 830 configured to extract features in one or more polarization representation spaces. As shown in FIG. 8B, the extraction of polarization images in operation 410 may include extracting, in operation 411, a first tensor in a first polarization representation space from the polarization raw frames from a first Stokes vector In operation 412, the feature extractor 800 further extracts a second tensor in a second polarization representation space from the polarization raw frames. For example, the polarization feature extractors 830 may include a DOLP extractor 840 configured to extract a DOLP ρ image 54 (e.g., a first polarization image or a first tensor in accordance with equation (8) with DOLP as the first polarization representation space) and an AOLP extractor 860 configured to extract an AOLP ϕ image 56 (e.g., a second polarization image or a second tensor in accordance with equation (9), with AOLP as the second polarization representation space) from the supplied polarization raw frames 18. As another example, the polarization representation spaces may include combinations of polarization raw frames in accordance with Stokes vectors. As further examples, the polarization representations may include modifications or transformations of polarization raw frames in accordance with one or more image processing filters (e.g., a filter to increase image contrast or a denoising filter). The derived feature maps 52, 54, and 56 may then be supplied to a predictor 900 for further processing, such as performing inferences (e.g., generating instance segmentation maps, classifying the images, and generating textual descriptions of the images).

While FIG. 8B illustrates a case where two different tensors are extracted from the polarization raw frames 18 in two different representation spaces, embodiments of the present disclosure are not limited thereto. For example, in some embodiments of the present disclosure, exactly one tensor in a polarization representation space is extracted from the polarization raw frames 18. For example, one polarization representation space of raw frames is AOLP and another is DOLP (e.g., in some applications, AOLP may be sufficient for detecting transparent objects or other optically challenging objects such as translucent, non-Lambertian, multipath inducing, and/or non-reflective objects). In some embodiments of the present disclosure, more than two different tensors are extracted from the polarization raw frames 18 based on corresponding Stokes vectors. For example, as shown in FIG. 8B, n different tensors in n different representation spaces may be extracted by the feature extractor 800, where the n-th tensor is extracted in operation 414.

Accordingly, extracting features such as polarization feature maps or polarization images from polarization raw frames 18 produces first tensors 50 from which transparent objects or other optically challenging objects such as translucent objects, multipath inducing objects, non-Lambertian objects, and non-reflective objects are more easily detected or separated from other objects in a scene. In some embodiments, the first tensors extracted by the feature extractor 800 may be explicitly derived features (e.g., hand crafted by a human designer) that relate to underlying physical phenomena that may be exhibited in the polarization raw frames (e.g., the calculation of AOLP and DOLP images, as discussed above). In some additional embodiments of the present disclosure, the feature extractor 800 extracts other non-polarization feature maps or non-polarization images, such as intensity maps for different colors of light (e.g., red, green, and blue light) and transformations of the intensity maps (e.g., applying image processing filters to the intensity maps). In some embodiments of the present disclosure the feature extractor 800 may be configured to extract one or more features that are automatically learned (e.g., features that are not manually specified by a human) through an end-to-end supervised training process based on labeled training data.

Computing Predictions Such as Segmentation Maps Based on Polarization Features Computed from Polarization Raw Frames

As noted above, some aspects of embodiments of the present disclosure relate to providing first tensors in polarization representation space such as polarization images or polarization feature maps, such as the DOLP ρ and AOLP ø images extracted by the feature extractor 800, to a predictor such as a semantic segmentation algorithm to perform multi-modal fusion of the polarization images to generate learned features (or second tensors) and to compute predictions such as segmentation maps based on the learned features or second tensors. Specific embodiments relating to semantic segmentation or instance segmentation will be described in more detail below.

Generally, there are many approaches to semantic segmentation, including deep instance techniques. The various the deep instance techniques bay be classified as semantic segmentation-based techniques (such as those described in: Min Bai and Raquel Urtasun. Deep watershed transform for instance segmentation. In Proceedings of the IEEE Conference on Computer Vision and Pattern Recognition, pages 5221-5229, 2017; Alexander Kirillov, Evgeny Levinkov, Bjoern Andres, Bogdan Savchynskyy, and Carsten Rother. Instancecut: from edges to instances with multicut. In Proceedings of the IEEE Conference on Computer Vision and Pattern Recognition, pages 5008-5017, 2017; and Anurag Arnab and Philip H S Torr. Pixelwise instance segmentation with a dynamically instantiated network. In Proceedings of the IEEE Conference on Computer Vision and Pattern Recognition, pages 441-450, 2017.), proposal-based techniques (such as those described in: Kaiming He, Georgia Gkioxari, Piotr Dollár, and Ross Girshick. Mask r-cnn. In Proceedings of the IEEE International Conference on Computer Vision, pages 2961-2969, 2017.) and recurrent neural network (RNN) based techniques (such as those described in: Bernardino Romera-Paredes and Philip Hilaire Sean Torr. Recurrent instance segmentation. In European Conference on Computer Vision, pages 312-329. Springer, 2016 and Mengye Ren and Richard S Zemel. End-to-end instance segmentation with recurrent attention. In Proceedings of the IEEE Conference on Computer Vision and Pattern Recognition, pages 6656-6664, 2017.). Embodiments of the present disclosure may be applied to any of these semantic segmentation techniques.

While some comparative approaches supply concatenated polarization raw frames (e.g., images I₀, I₄₅, I₉₀, and I₁₃₅ as described above) directly into a deep network without extracting first tensors such as polarization images or polarization feature maps therefrom, models trained directly on these polarization raw frames as inputs generally struggle to learn the physical priors, which leads to poor performance, such as failing to detect instances of transparent objects or other optically challenging objects. Accordingly, aspects of embodiments of the present disclosure relate to the use of polarization images or polarization feature maps (in some embodiments in combination with other feature maps such as intensity feature maps) to perform instance segmentation on images of transparent objects in a scene.

One embodiment of the present disclosure using deep instance segmentation is based on a modification of a Mask Region-based Convolutional Neural Network (Mask R-CNN) architecture to form a Polarized Mask R-CNN architecture. Mask R-CNN works by taking an input image x, which is an H×W×3 tensor of image intensity values (e.g., height by width by color intensity in red, green, and blue channels), and running it through a backbone network: C=B(x). The backbone network B(x) is responsible for extracting useful learned features from the input image and can be any standard CNN architecture such as AlexNet (see, e.g., Krizhevsky, Alex, Ilya Sutskever, and Geoffrey E. Hinton. “ImageNet classification with deep convolutional neural networks.” Advances in neural information processing systems. 2012.), VGG (see, e.g., Simonyan, Karen, and Andrew Zisserman. “Very deep convolutional networks for large-scale image recognition.” arXiv preprint arXiv:1409.1556 (2014).), ResNet-101 (see, e.g., Kaiming He, Xiangyu Zhang, Shaoqing Ren, and Jian Sun. Deep residual learning for image recognition. In Proceedings of the IEEE Conference on Computer Vision and Pattern Recognition, pages 770-778, 2016.), MobileNet (see, e.g., Howard, Andrew G., et al. “Mobilenets: Efficient convolutional neural networks for mobile vision applications.” arXiv preprint arXiv:1704.04861 (2017).), MobileNetV2 (see, e.g., Sandler, Mark, et al. “MobileNetV2: Inverted residuals and linear bottlenecks.” Proceedings of the IEEE Conference on Computer Vision and Pattern Recognition. 2018.), and MobileNetV3 (see, e.g., Howard, Andrew, et al. “Searching for MobileNetV3.” Proceedings of the IEEE International Conference on Computer Vision. 2019.)

The backbone network B(x) outputs a set of tensors, e.g., C={C₁, C₂, C₃, C₄, C₅}, where each tensor Cᵢ represents a different resolution feature map. These feature maps are then combined in a feature pyramid network (FPN) (see, e.g., Tsung-Yi Lin, Piotr Doll′ar, Ross Girshick, Kaiming He, Bharath Hariharan, and Serge Belongie. Feature pyramid networks for object detection. In Proceedings of the IEEE Conference on Computer Vision and Pattern Recognition, pages 2117-2125, 2017.), processed with a region proposal network (RPN) (see, e.g., Shaoqing Ren, Kaiming He, Ross Girshick, and Jian Sun. Faster r-cnn: Towards real-time object detection with region proposal networks. In Advances in Neural Information Processing Systems, pages 91-99, 2015.), and finally passed through an output subnetwork (see, e.g., Ren et al. and He et al., above) to produce classes, bounding boxes, and pixel-wise segmentations. These are merged with non-maximum suppression for instance segmentation.

Aspects of embodiments of the present invention relate to a framework for leveraging the additional information contained in polarized images using deep learning, where this additional information is not present in input images captured by comparative cameras (e.g., information not captured standard color or monochrome cameras without the use of polarizers or polarizing filters). Neural network architectures constructed in accordance with frameworks of embodiments of the present disclosure will be referred to herein as Polarized Convolutional Neural Networks (CNNs).

Applying this framework according to some embodiments of the present disclosure involves three changes to a CNN architecture:
(1) Input Image: Applying the physical equations of polarization to create the input polarization images to the CNN, such as by using a feature extractor 800 according to some embodiments of the present disclosure.
(2) Attention-fusion Polar Backbone: Treating the problem as a multi-modal fusion problem by fusing the learned features computed from the polarization images by a trained CNN backbone.
(3) Geometric Data Augmentations: augmenting the training data to represent the physics of polarization.

However, embodiments of the present disclosure are not limited thereto. Instead, any subset of the above three changes and/or changes other than the above three changes may be made to an existing CNN architecture to create a Polarized CNN architecture within embodiments of the present disclosure.

A Polarized CNN according to some embodiments of the present disclosure may be implemented using one or more electronic circuits configured to perform the operations described in more detail below. In the embodiment shown in FIG. 3, a Polarized CNN is used as a component of the predictor 900 for computing a segmentation map 20, as shown in FIG. 3.

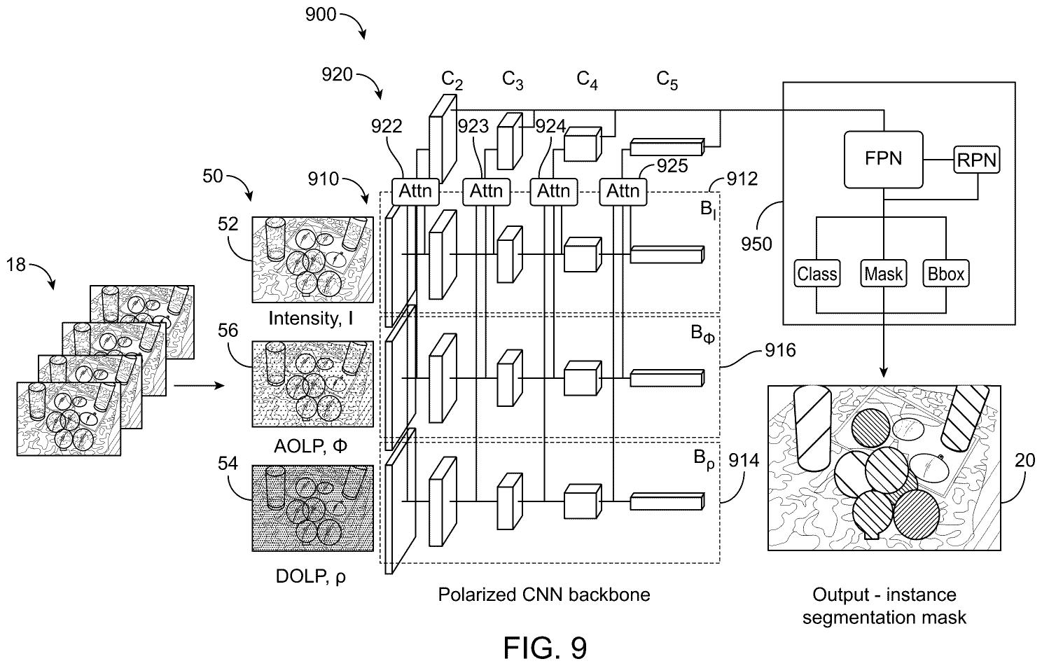

FIG. 9 is a block diagram depicting a Polarized CNN architecture according to one embodiment of the present invention as applied to a Mask-Region-based convolutional neural network (Mask R-CNN) backbone, where second tensors C (or output tensors such as learned feature maps) are used to compute an output prediction such as segmentation mask 20.

While some embodiments of the present disclosure relate to a semantic segmentation or instance segmentation using a Polarized CNN architecture as applied to a Mask R-CNN backbone, embodiments of the present disclosure are not limited thereto, and other backbones such as AlexNet, VGG, MobileNet, MobileNetV2, MobileNetV3, and the like may be modified in a similar manner.

In the embodiment shown in FIG. 9, derived feature maps 50 (e.g., including input polarization images such as AOLP ϕ and DOLP ρ images) are supplied as inputs to a Polarized CNN backbone 910. In the embodiment shown in FIG. 9, the input feature maps 50 include three input images: the intensity image (I) 52, the AOLP (ϕ) 56, the DOLP (ρ) 54 from equation (1) as the input for detecting a transparent object and/or other optically challenging object. These images are computed from polarization raw frames 18 (e.g., images I₀, I₄₅, I₉₀, and I₁₃₅ as described above), normalized to be in a range (e.g., 8-bit values in the range [0-255]) and transformed into three-channel gray scale images to allow for easy transfer learning based on networks pre-trained on the MSCoCo dataset (see, e.g., Tsung-Yi Lin, Michael Maire, Serge Belongie, James Hays, Pietro Perona, Deva Ramanan, Piotr Doll′ar, and C Lawrence Zitnick. Microsoft coco: Common objects in context. In European Conference on Computer Vision, pages 740-755. Springer, 2014.).

In the embodiment shown in FIG. 9, each of the input derived feature maps 50 is supplied to a separate backbone: intensity B_{I}(I) 912, AOLP backbone B_{ϕ}(ϕ) 914, and DOLP backbone B_{ρ}(ρ) 916. The CNN backbones 912, 914, and 916 compute tensors for each mode, or “mode tensors” (e.g., feature maps computed based on parameters learned during training or transfer learning of the CNN backbone, discussed in more detail below) C_{i,I}, C_{i,ρ}, C_{i,ϕ} at different scales or resolutions i. While FIG. 9 illustrates an embodiment with five different scales i, embodiments of the present disclosure are not limited thereto and may also be applied to CNN backbones with different numbers of scales.

Some aspects of embodiments of the present disclosure relate to a spatially-aware attention-fusion mechanism to perform multi-modal fusion (e.g., fusion of the feature maps computed from each of the different modes or different types of input feature maps, such as the intensity feature map I, the AOLP feature map ϕ, and the DOLP feature map ρ).

For example, in the embodiment shown in FIG. 9, the mode tensors C_{i,I}, C_{i,ρ}, C_{i,ϕ} (tensors for each mode) computed from corresponding backbones B_{I}, B_{ρ}, B_{ϕ} at each scale i are fused using fusion layers 922, 923, 924, 925 (collectively, fusion layers 920) for corresponding scales. For example, fusion layer 922 is configured to fuse mode tensors C_{2,I}, C_{2,ρ}, C_{2,ϕ} computed at scale i=2 to compute a fused tensor C₂. Likewise, fusion layer 923 is configured to fuse mode tensors C_{3,I}, C_{3,ρ}, C_{3,ϕ} computed at scale i=3 to compute a fused tensor C₃, and similar computations may be performed by fusion layers 924 and 925 to compute fused feature maps C₄ and C₅, respectively, based on respective mode tensors for their scales. The fused tensors Cᵢ (e.g., C₂, C₃, C₄, C₅), or second tensors, such as fused feature maps, computed by the fusion layers 920 are then supplied as input to a prediction module 950, which is configured to compute a prediction from the fused tensors, where the prediction may be an output such as a segmentation map 20, a classification, a textual description, or the like.

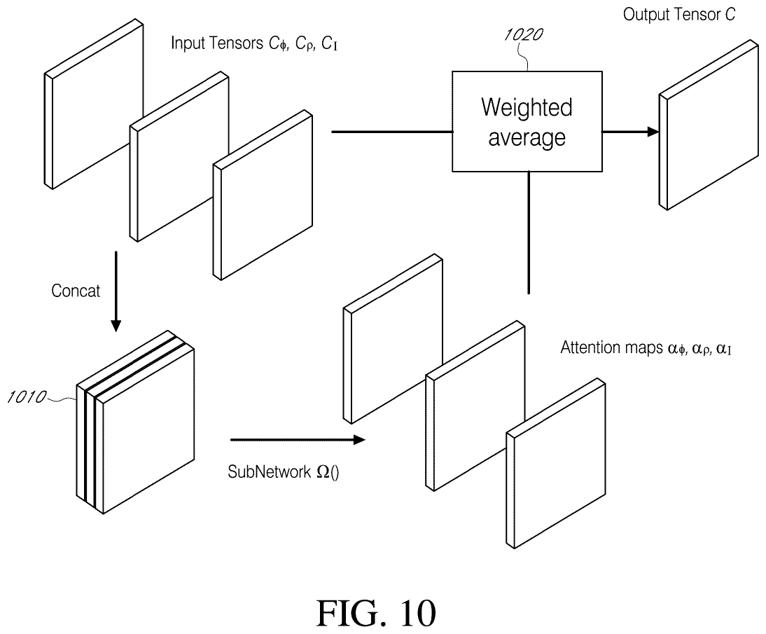

FIG. 10 is a block diagram of an i-th fusion layer among the fusion layers 920 that may be used with a Polarized CNN according to one embodiment of the present invention. As shown in FIG. 10, in some embodiments of the present disclosure, a fusion layer (e.g., each of the fusion layer 920) is implemented using an attention module, in which the predictor 900 concatenates the supplied input tensors or input feature maps C_{i,I}, C_{i,ρ}, C_{i,ϕ} computed by the CNN backbones for the i-th scale and to generate concatenated tensor 1010, where the concatenated tensor 1010 is processed through a set of trained convolutional layers or attention subnetwork Ωᵢ for the i-th.scale. The attention subnetwork Ωᵢ outputs a 3-channel image with the same height and width as the input tensors, and, in some embodiments, a softmax function is applied to each pixel of the 3-channel image to compute pixel-wise attention weights α for the i-th scale:

$$[ {α}_{i , ϕ} , {α}_{i , ρ} , {α}_{i , I} ] = softmax ( {Ω}_{i} ( [ {C}_{i , ϕ} , {C}_{i , ρ} , {C}_{i , I} ] ) ) \qquad ( 11 )$$

These attention weights are used to perform a weighted average 1020 per channel:

$${C}_{i} = {α}_{i , ϕ} {C}_{i , ϕ} + {α}_{i , ρ} {C}_{i , ρ} + {α}_{i , I} {C}_{i , I} \qquad ( 12 )$$

Accordingly, using an attention module allows a Polarized CNN according to some embodiments of the present disclosure to weight the different inputs at the scale i (e.g., the intensity/tensor or learned feature map C_{i,I}, the DOLP tensor or learned feature map C_{i,ρ}, and the AOLP tensor or learned feature map C_{i,ϕ} at scale i) based on how relevant they are to a given portion of the scene, where the relevance is determined by the trained attention subnetwork Ωᵢ in accordance with the labeled training data used to train the Polarized CNN backbone.

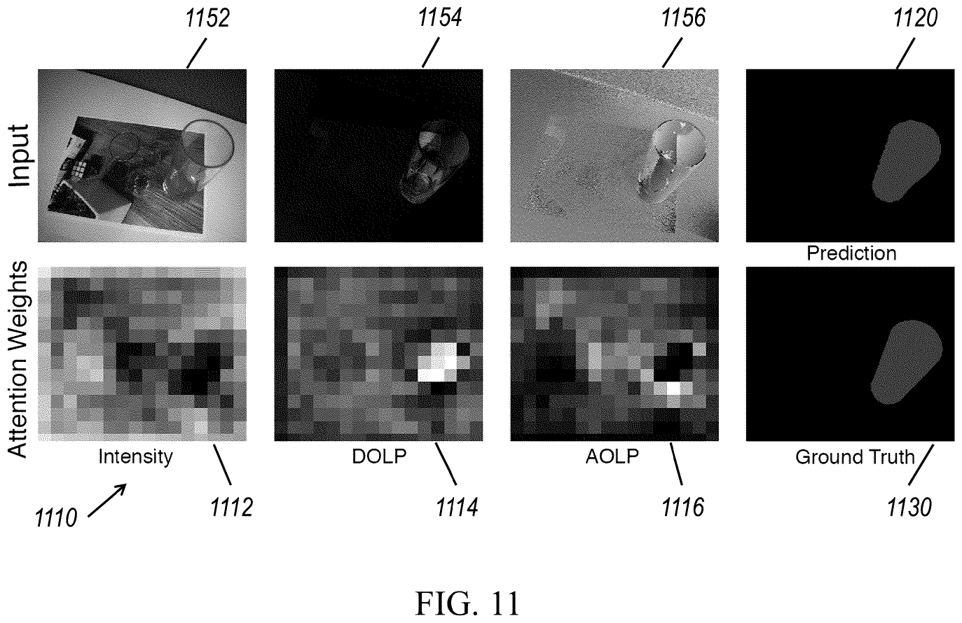

FIG. 11 depicts examples of attention weights computed by an attention module according to one embodiment of the present invention for different mode tensors (in different first representation spaces) extracted from polarization raw frames captured by a polarization camera. As shown in FIG. 11 (see, e.g., intensity image 1152), the scene imaged by the polarization camera includes a transparent glass placed on top of a print-out photograph, where the printed photograph depicts a transparent drinking glass (a print-out spoof of a drinking glass) and some background clutter.

As seen in FIG. 11, the learned attention weights 1110 are brightest on the DOLP 1114 and AOLP 1116 in the region around the real drinking glass and avoid the ambiguous print-out spoof in the intensity image 1152. Accordingly, the prediction module 950 can compute, for example, a segmentation mask 1120 that closely matches the ground truth 1130 (e.g., the prediction 1120 shows a shape that closely matches the shape of the transparent object in the scene).

In the embodiment shown in FIG. 9, the prediction module 950 is substantially similar to that used in a Mask R-CNN architecture and computes a segmentation map by combining the fused feature maps C using a feature pyramid network (FPN) and a region proposal network (RPN) as inputs to an output subnetwork for computing a Class, a Mask, and a bounding box (Bbox) for each instance of objects detected in the input images. the computed class, mask, and bounding boxes are then merged with non-maximum suppression to compute the instance segmentation map (or instance segmentation mask) 20.

As noted above, a Polarization CNN architecture can be trained using transfer learning based on an existing deep neural network that was trained using, for example, the MSCoCo dataset and a neural network training algorithm, such as backpropagation and gradient descent. In more detail, the Polarization CNN architecture is further trained based on additional training data representative of the inputs (e.g., using training polarization raw frames to compute training derived feature maps 50 and ground truth labels associated with the training derived feature maps) to the Polarization CNN as extracted by the feature extractor 800 from the polarization raw frames 18. These additional training data may include, for example, polarization raw frames captured, by a polarization camera, of a variety of scenes containing transparent objects or other optically challenging objects in a variety of different environments, along with ground truth segmentation maps (e.g., manually generated segmentation maps) labeling the pixels with the instance and class of the objects depicted in the images captured by the polarization camera.

In the case of small training datasets, affine transformations provide a technique for augmenting training data (e.g., generating additional training data from existing training data) to achieve good generalization performance. However, naively applying affine transformations to some of the source training derived feature maps such as the AOLP ϕ image does not provide significant improvements to the performance of the trained neural network and, in some instances, hurts performance. This is because the AOLP is an angle in the range of 0° to 360° (or 0 to 2π) that represents the direction of the electromagnetic wave with respect to the camera coordinate frame. If a rotation operator is applied to the source training image (or source training derived feature map), then this is equivalent to rotating the camera around its Z-axis (e.g., along the optical axis of the lens 12). This rotation will, in turn, change the orientation of the X-Y plane of the camera, and thus will change the relative direction of the electromagnetic wave (e.g., the angle of linear polarization). To account for this change, when augmenting the data by performing rotational affine transformations by an angle of rotation, the pixel values of the AOLP are rotated in the opposite direction (or counter-rotated or a counter-rotation is applied to the generated additional data) by the same angle. This same principle is also applied to other affine transformations of the training feature maps or training first tensors, where the particular transformations applied to the training feature maps or training first tensors may differ in accordance with the underlying physics of what the training feature maps represent. For example, while a DOLP image may be unaffected by a rotation transformation, a translation transformation would require corresponding changes to the DOLP due to the underlying physical behavior of the interactions of light with transparent objects or other optically challenging objects (e.g., translucent objects, non-Lambertian objects, multipath inducing objects, and non-reflective objects).

In addition, while some embodiments of the present disclosure relate to the use of CNN and deep semantic segmentation, embodiments of the present disclosure are not limited there to. In some embodiments of the present disclosure the derived feature maps 50 are supplied (in some embodiments with other feature maps) as inputs to other types of classification algorithms (e.g., classifying an image without localizing the detected objects), other types of semantic segmentation algorithms, or image description algorithms trained to generate natural language descriptions of scenes. Examples of such algorithms include support vector machines (SVM), a Markov random field, a probabilistic graphical model, etc. In some embodiments of the present disclosure, the derived feature maps are supplied as input to classical machine vision algorithms such as feature detectors (e.g., scale-invariant feature transform (SIFT), speeded up robust features (SURF), gradient location and orientation histogram (GLOH), histogram of oriented gradients (HOG), basis coefficients, Haar wavelet coefficients, etc.) to output detected classical computer vision features of detected transparent objects and/or other optically challenging objects in a scene.

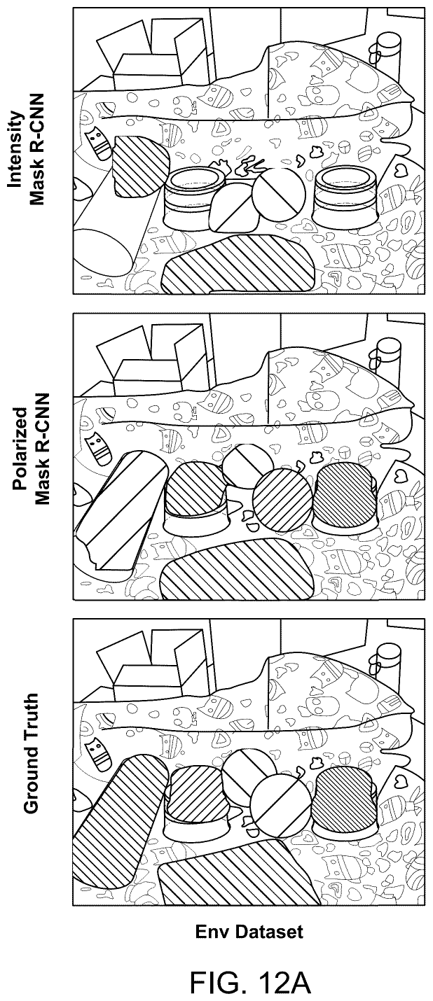

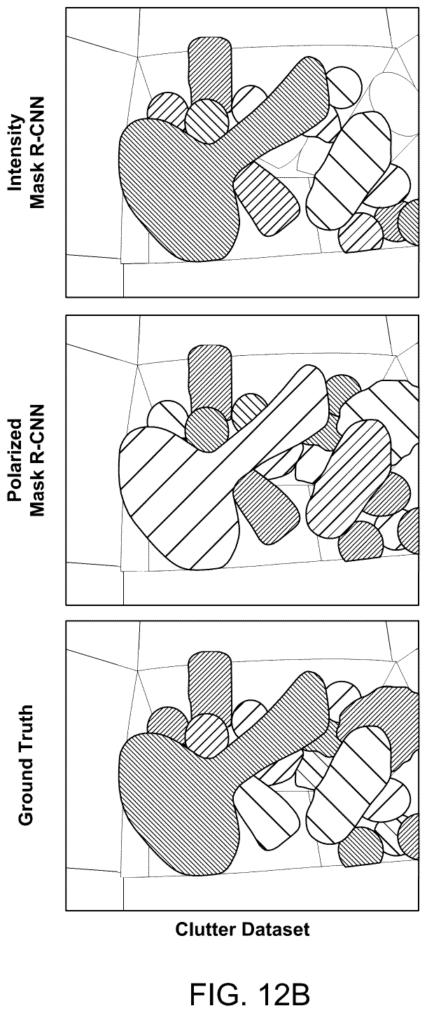

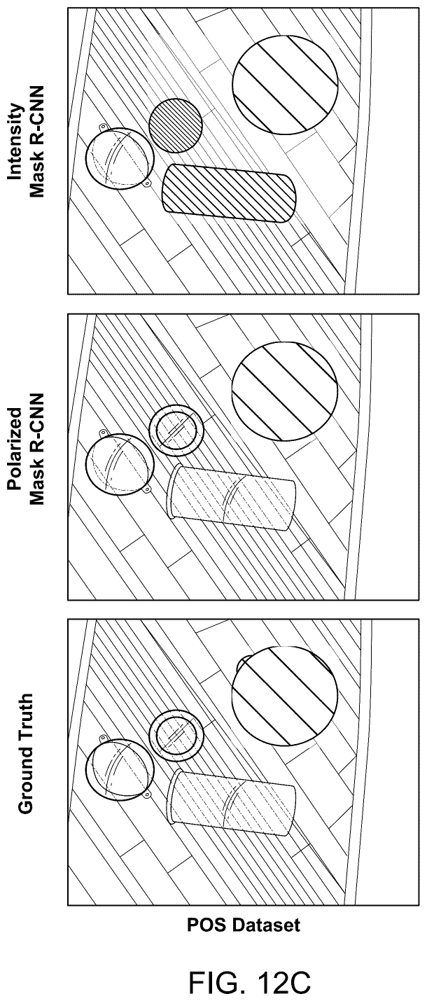

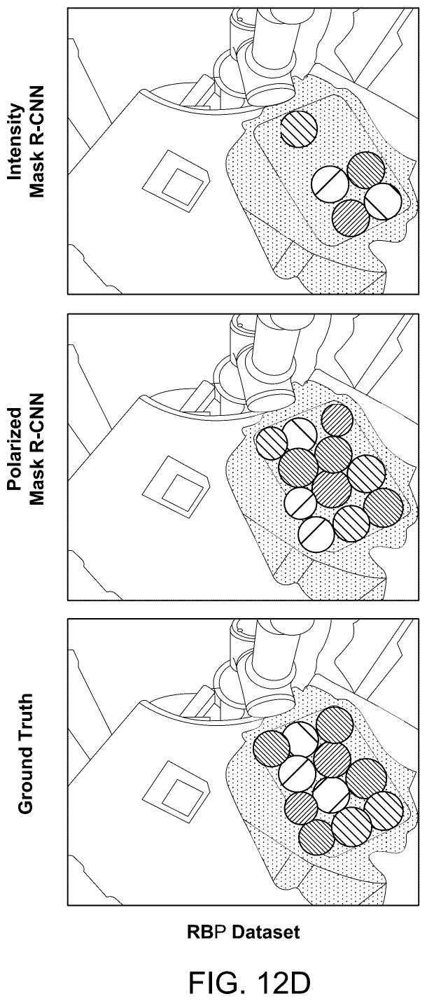

FIGS. 12A, 12B, 12C, and 12D depict segmentation maps computed by a comparative image segmentation system, segmentation maps computed by a polarized convolutional neural network according to one embodiment of the present disclosure, and ground truth segmentation maps (e.g., manually-generated segmentation maps). FIGS. 12A, 12B, 12C, and 12D depict examples of experiments run on four different test sets to compare the performance of a trained Polarized Mask R-CNN model according to one embodiment of the present disclosure against a comparative Mask R-CNN model (referred to herein as an “Intensity” Mask R-CNN model to indicate that it operates on intensity images and not polarized images).

The Polarized Mask R-CNN model used to perform the experiments was trained on a training set containing 1,000 images with over 20,000 instances of transparent objects in fifteen different environments from six possible classes of transparent objects: plastic cups, plastic trays, glasses, ornaments, and other. Data augmentation techniques, such as those described above with regard to affine transformations of the input images and adjustment of the AOLP based on the rotation of the images are applied to the training set before training. The four test sets include:
(a) A Clutter test set contains 200 images of cluttered transparent objects in environments similar to the training set with no print-outs.
(b) A Novel Environments (Env) test set contains 50 images taken of ˜6 objects per image with environments not available in the training set. The backgrounds contain harsh lighting, textured cloths, shiny metals, and more.
(c) A Print-Out Spoofs (POS) test set contains 50 images, each containing a 1 to 6 printed objects and 1 or 2 real objects.
(d) A Robotic Bin Picking (RBP) test set contains 300 images taken from a live demo of our robotic arm picking up ornaments (e.g., decorative glass ornaments, suitable for hanging on a tree). This set is used to test the instance segmentation performance in a real-world application.

For each data set, two metrics were used to measure the accuracy: mean average precision (mAP) in range of Intersection over Unions (IoUs) 0.5-0.7 (mAP_{.5:.7}), and mean average precision in the range of IoUs 0.75-0.9 (mAP_{.75:.9}). These two metrics measure coarse segmentation and fine-grained segmentation respectively. To further test generalization, all models were also tested object detection as well using the Faster R-CNN component of Mask R-CNN.

The Polarized Mask R-CNN according to embodiments of the present disclosure and the Intensity Mask R-CNN were tested on the four test sets discussed above. The average improvement is 14.3% mAP in coarse segmentation and 17.2% mAP in fine-grained segmentation. The performance improvement in the Clutter problem is more visible when doing fine-grained segmentation where the gap in performance goes from ˜1.1% mAP to 4.5% mAP. Therefore, the polarization data appears to provide useful edge information allowing the model to more accurately segment objects. As seen in FIG. 12A, polarization helps accurately segment clutter where it is ambiguous in the intensity image. As a result, in the example from the Clutter test set shown in FIG. 12A, the Polarized Mask R-CNN according to one embodiment of the present disclosure correctly detects all six instances of transparent objects, matching the ground truth, whereas the comparative Intensity Mask R-CNN identifies only four of the six instances of transparent objects.

For generalization to new environments there are much larger gains for both fine-grained and coarse segmentation, and therefore it appears that the intrinsic texture of a transparent object is more visible to the CNN in the polarized images. As shown in FIG. 12B, the Intensity Mask R-CNN completely fails to adapt to the novel environment while the Polarized Mask R-CNN model succeeds. While the Polarized Mask R-CNN is able to correctly detect all of the instances of trans parent objects, the Instance Mask R-CNN fails to detect some of the instances (see, e.g., the instances in the top right corner of the box).

Embodiments of the present disclosure also show a similarly large improvement in robustness against print-out spoofs, achieving almost 90% mAP. As such, embodiments of the present disclosure provide a monocular solution that is robust to perspective projection issues such as print-out spoofs. As shown in FIG. 12C, the Intensity Mask R-CNN is fooled by the printed paper spoofs. In the example shown in FIG. 12C, one real transparent ball is placed on printout depicting three spoof transparent objects. The Intensity Mask R-CNN incorrectly identifies two of the print-out spoofs as instances. On the other hand, the Polarized Mask R-CNN is robust, and detects only the real transparent ball as an instance.

All of these results help explain the dramatic improvement in performance shown for an uncontrolled and cluttered environment like Robotic Bin Picking (RBP). As shown in FIG. 12D, in the case of robotic picking of ornaments in low light conditions, the Intensity Mask R-CNN model is only able to detect five of the eleven instances of transparent objects. On the other hand, the Polarized R-CNN model is able to adapt to this environment with poor lighting and correctly identifies all eleven instances.

In more detail, and as an example of a potential application in industrial environments, a computer vision system was configured to control a robotic arm to perform bin picking by supplying a segmentation mask to the controller of the robotic arm. Bin picking of transparent and translucent (non-Lambertian) objects is a hard and open problem in robotics. To show the benefit of high quality, robust segmentation, the performance of a comparative, Intensity Mask R-CNN in providing segmentation maps for controlling the robotic arm to bin pick different sized cluttered transparent ornaments is compared with the performance of a Polarized Mask R-CNN according to one embodiment of the present disclosure.

A bin picking solution includes three components: a segmentation component to isolate each object; a depth estimation component; and a pose estimation component. To understand the effect of segmentation, a simple depth estimation and pose where the robot arm moves to the center of the segmentation and stops when it hits a surface. This works in this example because the objects are perfect spheres. A slightly inaccurate segmentation can cause an incorrect estimate and therefore a false pick. This application enables a comparison between the Polarized Mask R-CNN and Intensity Mask R-CNN. The system was tested in five environments outside the training set (e.g., under conditions that were different from the environments under which the training images were acquired). For each environment, fifteen balls were stacked, and the number of correct/incorrect (missed) picks the robot arm made to pick up all 15 balls (using a suction cup gripper) was counted, capped at 15 incorrect picks. The Intensity Mask R-CNN based model was unable to empty the bin regularly because the robotic arm consistently missed certain picks due to poor segmentation quality. On the other hand, the Polarized Mask R-CNN model according to one embodiment of the present disclosure, picked all 90 balls successfully, with approximately 1 incorrect pick for every 6 correct picks. These results validate the effect of an improvement of ˜20 mAP.

As noted above, embodiments of the present disclosure may be used as components of a computer vision or machine vision system that is capable of detecting both transparent objects and opaque objects.

In some embodiments of the present disclosure, a same predictor or statistical model 900 is trained to detect both transparent objects and opaque objects (or to generate second tensors C in second representation space) based on training data containing labeled examples of both transparent objects and opaque objects. For example, in some such embodiments, a Polarized CNN architecture is used, such as the Polarized Mask R-CNN architecture shown in FIG. 9. In some embodiments, the Polarized Mask R-CNN architecture shown in FIG. 9 is further modified by adding one or more additional CNN backbones that compute one or more additional mode tensors. The additional CNN backbones may be trained based on additional first tensors. In some embodiments these additional first tensors include image maps computed based on color intensity images (e.g., intensity of light in different wavelengths, such as a red intensity image or color channel, a green intensity image or color channel, and a blue intensity image or color channel). In some embodiments, these additional first tensors include image maps computed based on combinations of color intensity images. In some embodiments, the fusion modules 920 fuse all of the mode tensors at each scale from each of the CNN backbones (e.g., including the additional CNN backbones).

In some embodiments of the present disclosure, the predictor 900 includes one or more separate statistical models for detecting opaque objects as opposed to transparent objects. For example, an ensemble of predictors (e.g., a first predictor trained to compute a first segmentation mask for transparent objects and a second predictor trained to compute a second segmentation mask for opaque objects) may compute multiple predictions, where the separate predictions are merged (e.g., the first segmentation mask is merged with the second segmentation mask based, for example, on confidence scores associated with each pixel of the segmentation mask).

As noted in the background, above, enabling machine vision or computer vision systems to detect transparent objects robustly has applications in a variety of circumstances, including manufacturing, life sciences, self-driving vehicles, and

Accordingly, aspects of embodiments of the present disclosure relate to systems and methods for detecting instances of transparent objects using computer vision by using features extracted from the polarization domain. Transparent objects have more prominent textures in the polarization domain than in the intensity domain. This texture in the polarization texture can exploited with feature extractors and Polarized CNN models in accordance with embodiments of the present disclosure. Examples of the improvement in the performance of transparent object detection by embodiments of the present disclosure are demonstrated through comparisons against instance segmentation using Mask R-CNN (e.g., comparisons against Mask R-CNN using intensity images without using polarization data). Therefore, embodiments of the present disclosure

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

1-20. (canceled)

21. A computer-implemented method comprising:
receiving one or more polarization raw frames of a scene having one or more objects that are transparent or partially transparent;
computing, from the one or more polarization raw frames, a plurality of input images comprising an angle of linear polarization (AOLP) image, a degree of linear polarization image (DOLP), and an intensity image;
processing the plurality of input images using different respective neural network backbones, wherein each neural network backbone is a convolutional neural network that generates a respective output tensor;
generating a fused tensor from the respective outputs of the neural network backbones; and
providing the fused tensor as input to a prediction model that generates a prediction of the objects in the scene.

22. The method of claim 21, wherein the prediction comprises a segmentation mask that represents the edges of the objects in the scene.

23. The method of claim 21, wherein generating the fused tensor comprises processing the outputs of the neural network backbones using a fusion layer.

24. The method of claim 23, wherein the fusion layer concatenates the outputs of the neural network backbones.

25. The method of claim 24, wherein the fusion layer computes a weighted average of the outputs of the neural network backbones.

26. The method of claim 25, wherein the fusion layer uses attention weights that strengthen areas of an image according to polarization signals.

27. The method of claim 21, wherein the prediction model uses a feature pyramid network and a region proposal network to generate a segmentation mask.

28. A system comprising:
one or more computers and one or more storage devices storing instructions that are operable, when executed by the one or more computers, to cause the one or more computers to perform operations comprising:
receiving one or more polarization raw frames of a scene having one or more objects that are transparent or partially transparent;
computing, from the one or more polarization raw frames, a plurality of input images comprising an angle of linear polarization (AOLP) image, a degree of linear polarization image (DOLP), and an intensity image;
processing the plurality of input images using different respective neural network backbones, wherein each neural network backbone is a convolutional neural network that generates a respective output tensor;
generating a fused tensor from the respective outputs of the neural network backbones; and
providing the fused tensor as input to a prediction model that generates a prediction of the objects in the scene.

29. The system of claim 28, wherein the prediction comprises a segmentation mask that represents the edges of the objects in the scene.

30. The system of claim 28, wherein generating the fused tensor comprises processing the outputs of the neural network backbones using a fusion layer.

31. The system of claim 30, wherein the fusion layer concatenates the outputs of the neural network backbones.

32. The system of claim 31, wherein the fusion layer computes a weighted average of the outputs of the neural network backbones.

33. The system of claim 32, wherein the fusion layer uses attention weights that strengthen areas of an image according to polarization signals.

34. The system of claim 28, wherein the prediction model uses a feature pyramid network and a region proposal network to generate a segmentation mask.

35. One or more non-transitory computer storage media encoded with computer program instructions that when executed by one or more computers cause the one or more computers to perform operations comprising:
receiving one or more polarization raw frames of a scene having one or more objects that are transparent or partially transparent;
computing, from the one or more polarization raw frames, a plurality of input images comprising an angle of linear polarization (AOLP) image, a degree of linear polarization image (DOLP), and an intensity image;
processing the plurality of input images using different respective neural network backbones, wherein each neural network backbone is a convolutional neural network that generates a respective output tensor;
generating a fused tensor from the respective outputs of the neural network backbones; and
providing the fused tensor as input to a prediction model that generates a prediction of the objects in the scene.

36. The one or more computer storage media of claim 35, wherein the prediction comprises a segmentation mask that represents the edges of the objects in the scene.

37. The one or more computer storage media of claim 35, wherein generating the fused tensor comprises processing the outputs of the neural network backbones using a fusion layer.

38. The one or more computer storage media of claim 37, wherein the fusion layer concatenates the outputs of the neural network backbones.

39. The one or more computer storage media of claim 38, wherein the fusion layer computes a weighted average of the outputs of the neural network backbones.

40. The one or more computer storage media of claim 39, wherein the fusion layer uses attention weights that strengthen areas of an image according to polarization signals.
